(19) United States
(12) Patent Application Publication
(10) Pub. No.: US 2020/0160633 A1
(43) Pub. Date: May 21, 2020

(54) DETECTION OF UNAUTHORIZED ACCESS TO VEHICLE COMPARTMENTS

(71) Applicant: Xiaoju Science and Technology (Hong Kong) Limited, Mountain View, CA (US)

(72) Inventors: Jiang Zhang, San Jose, CA (US); Fengmin Gong, Los Gatos, CA (US); Xiaoyong Yi, Fremont, CA (US); Qi Chen, Burlingame, CA (US); Yu Wang, San Jose, CA (US)

(21) Appl. No.: 16/192,572

(22) Filed: Nov. 15, 2018

(51) Int. Cl. G07C 9/00; B60R 25/102

(52) U.S. Cl. CPC G07C 9/00309; G08B 29/183; B60R 25/102

(57) ABSTRACT

Aspects of the invention relate to a method for securing a vehicle compartment including receiving authorization data; setting a mode of operation of an access element based on the authorization data, the access element operable to control a locking mechanism of the vehicle compartment in a vehicle; receiving sensor data indicating that the vehicle compartment in the vehicle has been opened; and in response to the authorization data corresponding to the second mode of operation and the sensor data contemporaneously indicating that the vehicle compartment is opened: initiating a security protocol. The access element (e.g., user accessible button disposed in the vehicle cabin) can be configured to operate in a first mode of operation that allows the access element to control the locking mechanism and a second mode of operation that prevents the access element from controlling the locking mechanism.

### CROSS REFERENCES TO RELATED APPLICATIONS

The following regular U.S. patent applications (including this one) are being filed concurrently, and the entire disclosure of the other applications are incorporated by reference into this application for all purposes:
application Ser. No. ______, filed on ______, and entitled “PASSENGER AND VEHICLE MUTUAL AUTHENTICATION” (Attorney Docket No. 103343-000100US-1097150); and
application Ser. No. ______, filed on ______, and entitled “METHOD AND SYSTEM FOR MANAGING ACCESS OF A VEHICLE COMPARTMENT” (Attorney Docket No. 103343-000300US-1097165).

### BACKGROUND

Modern vehicles include many components, such as an engine and transmission, as well as electronic circuits such as sensors and processing modules, LiDAR modules, electronic control modules (ECUs), etc. Many of these components are housed within a vehicle compartment. The vehicle compartment typically has a movable cover, such as a hood or a door, which can be opened when an actuator (e.g., a physical button, a software button, etc.) is activated to provide access to the components housed within the vehicle compartment. Under normal operation (e.g., when the vehicle is moving), the vehicle compartment is locked such that the movable cover remains closed even when the actuator is activated. When the vehicle is stationary, a user (e.g., a driver, a passenger, a technician, or any person who has access to the cabin) can unlock the vehicle compartment from within the cabin to access the interior of the vehicle compartment.

Typically, a person who can gain entry into the cabin has full, unlimited access to the vehicle compartment. Such arrangements, however, can create security risks. For example, an intruder may break into the passenger cabin and gain access to the vehicle compartment, making ECUs and/or the Controller Area Network (CAN) bus vulnerable to attack. Also, in the context of ridesharing and autonomous driving, a passenger of an autonomous vehicle can gain access to the vehicle compartment in the absence of the owner of the vehicle being present. In both cases, the components housed within the vehicle compartment can be subject to unauthorized access, which can compromise the security of the vehicle. On the other hand, restricting access to the vehicle compartment can create inconveniences and delays for maintenance work on the vehicle. Better solutions are needed that can balance these security and convenience of access considerations.

### BRIEF SUMMARY

In some embodiments, a method for securing a vehicle compartment can include receiving authorization data, setting a mode of operation of an access element based on the authorization data, the access element operable to control a locking mechanism of the vehicle compartment in a vehicle, receiving sensor data indicating that the vehicle compartment in the vehicle has been opened, and in response to the authorization data corresponding to the second mode of operation and the sensor data contemporaneously indicating that the vehicle compartment is opened, initiating a security protocol. The access element can be configured to operate in a first mode of operation that allows the access element to control the locking mechanism and a second mode of operation that prevents the access element from controlling the locking mechanism. In some implementations, the access element can be a user accessible button disposed in a cabin of the vehicle and, in response to being activated, may be configured to toggle between the first mode of operation and the second mode of operation.

In certain embodiments, the authorization data can indicate whether a user accessing the vehicle has security privileges, where the access element is set to the first mode of operation when the authorization data indicates that the user has security privileges, and where the access element is set to the second mode of operation when the authorization indicates that the user does not have security privileges. In some aspects, the sensor data can further indicate when one or more components within the vehicle compartment has been tampered with, and initiating the security protocol may be further performed in response to the authorization data corresponding to the second mode of operation and the sensor data contemporaneously indicating that the one or more components within the vehicle compartment has been tampered with. The sensor data can be received from one or more motion sensors configured to detect when the vehicle compartment is opened. In some implementations, the sensor data is received from one or more light sensors configured to detect when the vehicle compartment is opened based on a change of an ambient light intensity within the vehicle compartment. Initiating a security protocol can include one or more of: triggering an alarm system, alerting one or more security entities, and transmitting an alert to vehicle fleet management server, the vehicle fleet management server providing the authorization data.

In certain embodiments, a security system for a vehicle includes an electronic control unit (ECU) disposed in the vehicle, an inertial measurement unit (IMU) physically coupled to the electronic control unit and configured to detect a movement of the ECU, and an access control module (ACM) communicatively coupled to the ECU and IMU, the ACM configured to receive security data corresponding to a security privilege for a user of the vehicle. In some embodiments, the ACM can be configured to trigger an alarm in response to the security data indicating that the user does not have a security privilege and the IMU contemporaneously detecting a movement of the ECU. The ECU can be housed in a vehicle compartment inside the vehicle, wherein the ACM is configured to control access to the vehicle compartment based on the security privilege for the user.

In some aspects of the invention, an access element can be disposed in a cabin of the vehicle that is operable to control a locking mechanism of the vehicle compartment, where the ACM enables the access element in response to determining that the user has the security privilege, and where the ACM disables the access element in response to determining that the user does not have the security privilege. The system can further include a light sensor configured to detect a change in an ambient light within a perimeter of the ECU, and where the ACM can be further configured to control access to the vehicle compartment based on the light sensor contemporaneously detecting changes in the ambient light within the perimeter of the ECU that is greater than a threshold value. In some cases, changes in the ambient light may not be contemporary (e.g., it occurred within the last 1, 5, 10 minutes, or other suitable time period). In some cases, the perimeter may be any suitable area around and including the ECU. For instance, the perimeter can be a volumetric area defined by dimensions, defined by a range of detection of the light sensor, or a combination thereof. A threshold value can be any suitable change in detected light (typically measured in lumens), such as a change in 1, 5, 10 lumens or other suitable amount over a range of time (current, over a 10 second window, etc.).

In further embodiments, the ACM can be configured to trigger the alarm in response to the security data indicating that the user does not have a security privilege, the IMU contemporaneously detecting a movement of the ECU, and the ACM contemporaneously receiving data indicating that the vehicle is not in motion. For instance, the IMU may detect movement of the ICU while the vehicle is in motion. Alternatively or additionally, one or more additional IMUs configured on the vehicle may be used so that a difference between the IMU on the ECU and the IMU(s) on the vehicle can be compared. In some cases, if the IMUs measure similar movement (e.g., displacement, acceleration, speed, etc.), this may reflect that the vehicle is in motion. However, if the IMUs reflect different or contrary movement, this can be indicative of the IMU being moved and/or tampered with and not related primarily to vehicle motion. In some embodiments, the ACM may be further configured to: alert one or more security entities, or transmit an alert to vehicle fleet management server, the vehicle fleet management server providing the authorization data.

In some embodiments, a system for securing a vehicle compartment may include one or more processors and one or more non-transitory computer readable mediums storing instructions configured to cause the one or more processors to perform operations including: receiving authorization data; setting a mode of operation of an access element based on the authorization data, receiving sensor data indicating that the vehicle compartment in the vehicle has been opened, and in response to the authorization data corresponding to the second mode of operation and the sensor data contemporaneously indicating that the vehicle compartment is opened: initiating a security protocol. In some aspects, the access element can be operable to control a locking mechanism of the vehicle compartment in a vehicle, where the access element is configured to operate in: a first mode of operation that allows the access element to control the locking mechanism and a second mode of operation that prevents the access element from controlling the locking mechanism. The access element can be a user accessible button disposed in a cabin of the vehicle and, in response to being activated, is configured to toggle between the first mode of operation and the second mode of operation. The authorization data may indicate whether a user accessing the vehicle has security privileges, where the access element can be set to the first mode of operation when the authorization data indicates that the user has security privileges, and where the access element can be set to the second mode of operation when the authorization indicates that the user does not have security privileges. In some embodiments, the sensor data can further indicate when one or more components within the vehicle compartment has been tampered with, and initiating the security protocol can be further performed in response to the authorization data corresponding to the second mode of operation and the sensor data contemporaneously indicating that the one or more components within the vehicle compartment has been tampered with. The sensor data can be received from one or more motion sensors configured to detect when the vehicle compartment is opened. In some cases, the sensor data can be received from one or more light sensors configured to detect when the vehicle compartment is opened based on a change of an ambient light intensity within the vehicle compartment. In certain embodiments, initiating a security protocol can include one or more of: triggering an alarm system, alerting one or more security entities, and transmitting an alert to vehicle fleet management server, the vehicle fleet management server providing the authorization data.

This summary is not intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim.

The foregoing, together with other features and examples, will be described in more detail below in the following specification, claims, and accompanying drawings.

### BRIEF DESCRIPTION OF THE DRAWINGS

The detailed description is set forth with reference to the accompanying figures.

FIG. 1 shows a security and safety platform utilizing certain embodiments of the disclosed techniques described herein.

FIG. 2 shows a block diagram of an example of a vehicle electronic system in which the disclosed techniques can be implemented, according to certain embodiments.

FIG. 3A shows and examples of a vehicle compartment security system, according to certain embodiments.

FIG. 3B shows an example of generation and processing of temporary access tokens between a management server and an access control module, according to certain embodiments.

FIG. 3C shows an example of a secure transmission of an access token from a management server to an access control module, according to certain embodiments.

FIG. 4A shows a simplified flow diagram of method for controlling an access to a vehicle compartment, according to certain embodiments.

FIG. 4B shows a simplified flow diagram of method for controlling an access to a vehicle compartment, according to certain embodiments.

FIG. 5 shows a simplified flow diagram of method for controlling the access to a vehicle compartment, according to certain embodiments.

FIG. 6 shows a simplified flow diagram of method for controlling the access to a vehicle compartment, according to certain embodiments.

FIG. 7 shows a simplified flow diagram of method for controlling the access to a vehicle compartment, according to certain embodiments.

FIG. 8 shows a simplified flow diagram of method for controlling the access to a vehicle compartment and or vehicle components, according to certain embodiments.

FIG. 9 a simplified block diagram of an example of a mobile device, such as a wireless mobile device (e.g., a smart phone, a smart watch, a touch pad, etc.), for implementing some techniques disclosed herein, according to certain embodiments.

FIG. 10 illustrates an example computer system for implementing some of the embodiments disclosed herein.

### DETAILED DESCRIPTION

Aspects of the present disclosure relate generally to security systems, and in particular to sensor-based, vehicle resource access detection systems, according to certain embodiments.

In the following description, various examples of a vehicle security system will be described. For purposes of explanation, specific configurations and details are set forth in order to provide a thorough understanding of the embodiments. However, it will be apparent to one skilled in the art that certain embodiments may be practiced or implemented without every detail disclosed. Furthermore, well-known features may be omitted or simplified in order to prevent any obfuscation of the novel features described herein.

### Conceptual Overview of Certain Embodiments

Securing an ECU or a vehicle compartment housing an ECU can be crucial in enhancing security and safety protection for the entire vehicle. As described above, the vehicle compartment may house critical mechanical and electronic components. Securing the vehicle compartment can prevent unauthorized access to those components, which would otherwise compromise the security and safety of the vehicle. For example, the electronic components in the vehicle compartment may be electrically coupled to other electronic components (e.g., the infotainment system, the navigation system, etc.) of the vehicle via a Controller Area Network (CAN) bus or other system coupling infrastructure. A malicious passenger (attacker) can access the vehicle compartment and tamper with the electronic components (e.g., electronic control units (ECU)) within the vehicle to perform an attack on the other electronic components over the CAN bus. For example, the malicious passenger can send commands to the ECU to control the vehicle. As another example, the malicious passenger can modify a record of usage of the vehicle or gain access to other services provided by the vehicle, which the user is not authorized to access, etc., by tampering with the ECU. An attacker may further tamper with the autonomous driving (AD) control system housed within the vehicle compartment, which can compromise the safe operation of the vehicle. Further still, the attacker may attempt to physically remove one or more ECUs or other valuable circuitry from the vehicle.

Thus, certain embodiments may include systems and methods directed to detecting unauthorized physical access to one or more vehicle compartments and/or electronic circuitry (e.g., ECU) using one or more sensor-based systems. In some cases, a physical or software-based button (e.g. on a touch screen) may be physically accessible inside the vehicle (or on a mobile device). The button, which can be controlled by an access control module (ACM), may be configured to open and/or unlock one or more vehicle compartments (e.g., open a hood of an engine bay for a vehicle). The button may be normally disabled, except when enabled by an authorized entity, which may occur for instance when the entity has checked into the vehicle and has the privilege to access the vehicle compartment(s), such as the vehicle owner, administrator (e.g., operating a fleet of vehicles), or the like, or entities with a temporary authorization to access the vehicle (e.g., repair technician).

In some embodiments, an unauthorized access to the vehicle compartment may correspond to an indication that the vehicle compartments has been opened, tampered with, or otherwise accessed while the button is disabled. Some non-limiting examples of sensors that can detect whether the vehicle compartment(s) and/or components therein (e.g., ECU) have been tampered with may include a position sensor to detect when a cover (e.g., hood) for a vehicle compartment (e.g., engine bay) has been opened, a position sensor and/or motion sensor (e.g., inertial measurement unit (IMU)) to detect when certain components (e.g., ECU) have been moved or tampered with, a light sensor to detect when an compartment is opened (assuming the compartment is dark and ambient light exists outside of the compartment), or other suitable sensing system, and any combination thereof. In each case, once an unauthorized access is detected, an alarm protocol (based on one or more security policies) may be triggered by the ACM, which can include sounding an alarm; notifying a server (e.g., fleet management server) or security personal (e.g., the local police) of the nature of the unauthorized access, the location of the vehicle, and other pertinent information; take video and/or audio surveillance of the attacker and surrounding environment, or other suitable action defined in the corresponding security policies. These embodiments and those throughout the present document allow one or more vehicle compartments to be accessed when there is a justified need, while simultaneously reducing the aforementioned security risks posed to the vehicle.

### Typical System Environment for Certain Embodiments

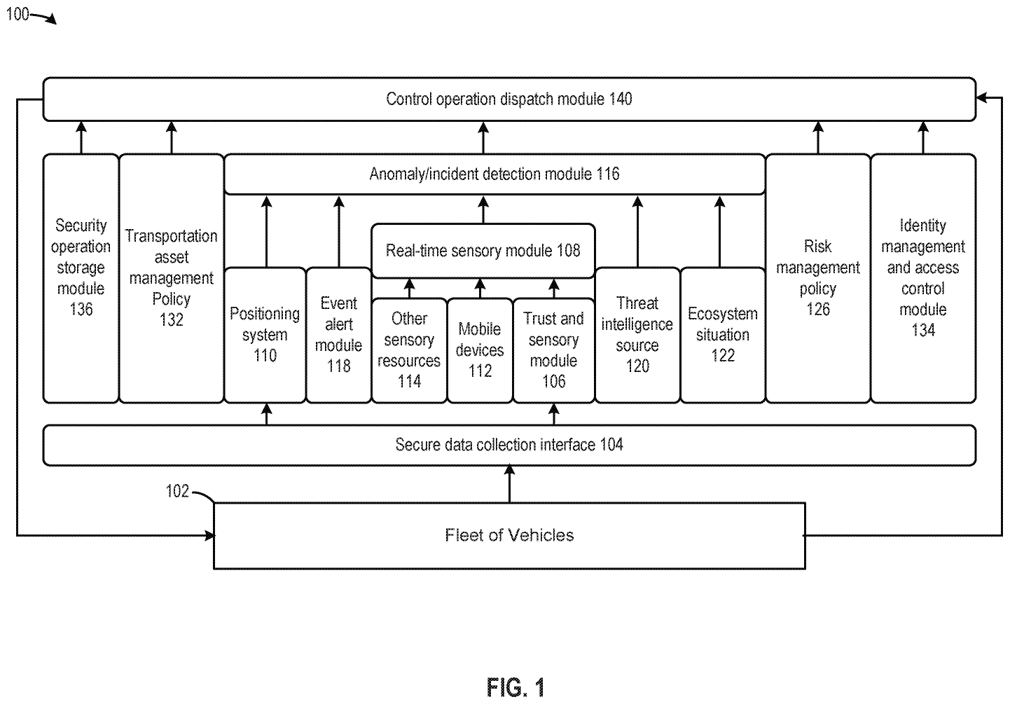

FIG. 1 illustrates a security and safety platform 100 in which the disclosed techniques can be implemented. Security and safety platform 100 can manage the security and safety of a fleet of vehicles, including fleet of vehicles 102. Security and safety platform 100 can collect various operation data of fleet of vehicles 102, as well as environment data from other sources related to an environment in which the fleet of vehicles operate. Security and safety platform 100 can process the data to detect incidents/anomalies, and determine a corresponding risk scenario. Security and safety platform 100 can then determine one or more control operations based on the risk scenario. Security and safety platform 100 can also take into account other information such as management policies, pre-configured security operations, access control rules, etc., to formulate the control operations. Security and safety platform 100 can then dispatch instructions to fleet of vehicles 102 to perform the control operations to mitigate the risk. Fleet of vehicles 102 can include various types of vehicles operating in different operation environments and providing different services. For example, fleet of vehicles 102 can include vehicles that provide private transportation, public transportation, ride-sharing, etc. Fleet of vehicles 102 can include autonomous driving (AD) vehicles, manually-driven vehicles, etc.

Security and safety platform 100 can further include a secure data collection interface 104 to collect various operation data from fleet of vehicles 102. The operation data may include, for example, location data, speed data, sensor data (e.g., sensor data from a cabin door sensor, a hood sensor, tire pressure sensors, etc.), status data from various electronic components of the vehicles, etc. To protect privacy and to avoid the operation data from being intercepted, secure data collection interface 104 can establish a secure wireless channel with each vehicle of the fleet, and receive, in real-time, the operation data from the vehicles via the secure wireless channels. Security and safety platform 100 further includes a trust and sensory module 106 which can provide the credential information (e.g., public key certificate, etc.) to perform mutual authentication with fleet of vehicles 102 to authenticate security and safety platform 100 and to establish the secure wireless channels with secure data collection interface 104. Trust and sensory module 106 can also perform certain post-processing operations on the real-time operation data, such as identifying the vehicles and the sensors that provide the sensor data, extracting the time information, etc., from the real-time operation data, and provide the post-processed real-time operation data to a real-time sensory module 108. The location and speed data from secure data collection interface 104 can also be processed by positioning system 110 to generate and/or update position information of each vehicle of fleet of vehicles 102. As to be described below, the position information of the vehicles can be correlated with other aspects of the real-time operation data provided by the vehicle to detect safety and/or security risks.

In addition to the real-time operation data from fleet of vehicles 102 (provided by trust and sensory module 106), real time sensory module 108 can also obtain real-time environment data related to the environment(s) in which the fleet of vehicles operate in. As shown in FIG. 1, the real-time environment data can be obtained from mobile devices 112 and other sensory resources 114, among others. The real-time environment data may include, for example, reports provided by mobile devices 112, which can be operated by the passengers of fleet of vehicles 102, other road users, pedestrians, repair service personnel, etc. The reports may include, for example, traffic condition reports, road condition reports (e.g., whether a road is closed or otherwise not suitable for driving), etc. Mobile devices 112 can also transmit access requests to access certain features and resources of fleet of vehicles 102 by the passengers, the repair service personnel, etc. In addition, other sensory resources 114 may include fixed and/or mobile sensors installed as part of a city infrastructure to provide environment sensory data including, for example, weather conditions, traffic conditions, etc. Real-time sensory module 108 can provide the real-time environment data (e.g., reports from mobile devices 112, environment sensory data from other sensory resources 114, etc.) as well as the real-time operation data (from trust and sensory module 106) to anomaly/incident detection and response module 116, which may also be configured to receive position information of fleet of vehicles 102 from positioning system 110. In some embodiments, real-time sensory module 108 can be configured to receive real time data, the real-time environment data, and the real-time operation data (including the position information) to detect safety and/or security risks.

In addition to real-time environment data and real-time operation data, anomaly/incident detection and response module 116 can receive additional information/data from other sources to perform safety and/or security risk detection and provide an appropriate response. For example, anomaly/incident detection and response module 116 can receive alerts/reports about certain public events (which can pre-planned, or based on real-time reporting, such as hazardous weather conditions, traffic accidents, etc.) at different locations and times from event alert module 118 and provide a response. Anomaly/incident detection and response module 116 can also monitor network activities and detect potential cyber security attacks. Anomaly/incident detection and response module 116 can also receive, from threat intelligence source 120, warnings of potential security threats, such as potential criminal, terrorist, or other hostile actions, at different locations and times. In addition, ecosystem situation 122 may also provide, for example, environment and operation data from other fleets of vehicles operated by other vendors. All these data can be integrated by anomaly/incident detection and response module 116 to perform safety and/or security risks detection and response.

Anomaly/incident detection and response module 116 can include logic to analyze the real-time environment data and real-time operation data (from real-time sensory module 108), position information of fleet of vehicles 102 (from positioning system 110), public events alerts/reports (from event alert module 118), warnings of potential security threats (from threat intelligence source 120), and ecosystem data (from ecosystem situation 122), and identify potential safety and/or security risks. The analysis can be based on, for example, correlating operation data with time and location information of fleet of vehicles 102, detecting patterns of operations, etc., while taking into consideration warnings and alerts about known events and threats. Anomaly/incident detection and response module 116 can also generate a risk assessment including, for example, an identification of the safety and/or security risk, time and location of the risk, severity of the risk, etc., and send the result of the analysis to control operation dispatch module 140.

As an illustrative example, real-time sensory module 108 may receive sensor data from a vehicle of fleet of vehicles 102. The sensor data may be generated by a sensor at a vehicle compartment which houses the electronic control unit (ECU) of the vehicle. Anomaly/incident detection and response module 116 may receive the sensor data from real-time sensory module 108, and determine that there is a current (or at a certain pre-determined time) attempt to access the vehicle compartment. Anomaly/incident detection and response module 116 may determine whether such an event indicates a potential security or safety risk. To make the determination, anomaly/incident detection and response module 116 may obtain additional data from other sources, such as position system 110, threat intelligence source 120, etc., as well as login data and access request provided by users who try to access vehicles 102, and correlate the additional data with the event. For example, anomaly/incident detection and response module 116 may determine, based on position information of the vehicle from positioning system 110, whether the vehicle is at a location where the compartment door is not expected to be opened. If the position information indicates that vehicle is at a repair shop, at the vehicle owner's premise, etc., at the time when the attempt to access the compartment door is detected, and a temporary access request to a vehicle compartment and/or ECU is received, anomaly/incident detection and response module 116 may determine that the attempted access does not pose a security risk and can grant access to the vehicle compartment and/or ECU. As another example, if the information provided by threat intelligence source 120, together with the position information from positioning system 110, indicate that the vehicle is located in an area where car theft is rampant, and an access attempt from a user who has no access right to the vehicle compartment and/or ECU is detected, anomaly/incident detection and response module 116 may determine that the attempted access poses a heightened security risk and can provide an appropriate response (e.g., disabling the access to the vehicle component/ECU, by issuing an alert to local law enforcement, etc.).

Control operation dispatch module 140 can receive the risk assessment (e.g., the identified risk, a severity of the risk, etc.) for a vehicle from anomaly/incident detection and response module 116, and determine an action to be performed at the vehicle to mitigate a safety/security risk based on the risk assessment. The determination can be based on applying a set of rules to the identified risk and the severity of the risk, and the rules can come from various sources. For example, as shown in FIG. 1, control operation dispatch module 140 can receive rules defined in risk management policy storage 126 and transportation asset management policy storage 132, and apply the rules to determine the action. Referring back to the vehicle compartment access example above, transportation asset management policy storage 132 may provide rules that specify that the compartment of a vehicle stores critical electronic components, and authorization is needed before granting access to the compartment. Risk management policy storage 126 can define a set of operations to determine whether to authorize access to the compartment (e.g., requesting credential information from the requester). For example, in a case where the requester for the vehicle compartment access is a registered user (e.g., a driver, a passenger, etc.) of fleet of vehicles 102, control operation dispatch module 140 can operate with an identity management and access control module 134 to authenticate the identity of the requester, and to determine the access right of the requester with respect to the vehicle compartment. In cases where anomaly/incident detection and response module 116 determines that the severity of a risk is high, control operation dispatch module 140 can perform security operations based on definitions stored in security operation storage 136 to mitigate the security risk. For example, threat intelligence source 120 may indicate that there is high likelihood that the entire fleet of vehicles 102 may be under cyberattack. Security operations storage 136 may define that control operation dispatch module 140 should disable the passenger's access to the Internet for each vehicle of the fleet (while maintaining the network connection between the vehicles and security and safety platform 100) when the risk of cyberattack is high. Control operation dispatch module 140 can then configure (or send instructions to) fleet of vehicles 102 to disable Internet access for the passengers.

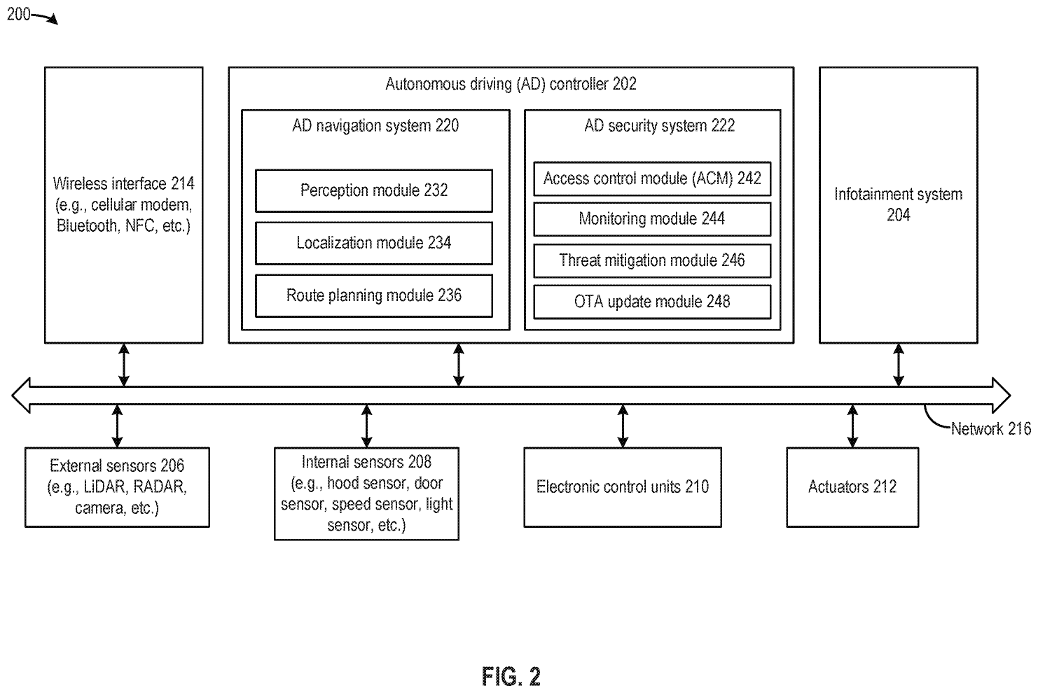

FIG. 2 illustrates a block diagram of an example of a vehicle electronic system 200 in which the disclosed techniques can be implemented. Vehicle electronic system 200 can be part of security and safety platform 100 of FIG. 1. Vehicle electronic system 200 can also be part of an autonomous driving (AD) vehicle and can include various electronic components including, for example, an AD controller 202, an infotainment system 204, external sensors 206, internal sensors 208, a plurality of electronic control units (ECU) 210, a plurality of actuators 212, and a wireless interface 214. The electronic components are coupled to network 216. Via network 216, the electronic components can communicate with each other. In some examples, network 216 can include a CAN bus. In some examples, some of the components can also be connected directly and not via network 216. For example, external sensors 206, internal sensors 208, and actuators 212 connected directly to AD controller 202, so that AD controller 202 can detect and control unauthorized access to the vehicle even when network 216 is not working.

AD controller 202 can include components to support various operations related to autonomous driving including, for example, navigation and control, security and protection, etc. In some embodiments, the modules and subsystems of AD controller 202 can be implemented in the form of software instructions executable on a general purpose computer. In some embodiments, the modules and subsystems of AD controller 202 can be implemented on an integrated circuit (IC) such as Application Specific Integrated Circuit (ASIC), field-programmable gate array (FPGA), System-on-Chip (SoC), etc. In some embodiments, AD controller 202 can include AD navigation subsystem 220 and AD security subsystem 222. AD navigation subsystem 220 can obtain sensor data from external sensors 206 which may include, for example, LiDAR data, RADAR data, camera image data, etc., perform navigation operations based on the sensor data, and control the speed and the steering of the vehicle to bring the vehicle to a destination. As shown in FIG. 2, AD navigation subsystem 220 can include a perception module 232, a localization module 234, and a planning module 236. Perception module 232 can analyze the sensor data from external sensors 206 to generate perception data about an environment the vehicle is operating in to determine a location of the vehicle. For example, perception module 232 can analyze the LiDAR and RADAR data to determine, for example, a distance between obstacles (e.g., landmarks, buildings, etc.) and the vehicle. Perception module 232 can also analyze the image data from the cameras to extract, for examples, images of landmarks, buildings, etc. Localization module 234 can obtain the perception data from perception module 232 and determine, for example, a direction of travel of the vehicle, a location of the vehicle, etc. For example, localization module 234 can store a set of locations of landmarks within a locale. Localization module 234 can determine a current position of the vehicle within the locale based on a landmark identified from the image data, as well as distance from the identified landmark based on the LiDAR and/or RADAR data. Planning module 236 can determine one or more control decisions of the vehicle (e.g., a direction of travel of the vehicle, a speed of the vehicle, etc.) based on the current position of the vehicle and a destination of the vehicle. Planning module 236 can transmit control signals via network 216 to electronic control units 210 to control the steer angle of the vehicle, the throttle of the engine of the vehicle (to control its speed), etc., based on the control decisions. Planning module 236 can also transmit the control decisions to infotainment system 204 for output. For example, infotainment system 204 may provide navigation output (e.g., audio and/or video feedback) to the passengers to let them know the location of the vehicle and which direction the vehicle is heading.

In addition, AD security subsystem 222 can provide security and protection to the vehicle by regulating access to various features and functions of the vehicle and by performing operations to minimize security and safety threats. As shown in FIG. 2, AD security subsystem 222 can include an access control module (ACM) 242, a monitor module 244, a threat mitigation module 246, and an over-the-air (OTA) update module 248. ACM 242 can control access to various software and hardware components of the vehicle. For example, ACM 242 can regulate access to the passenger cabin, the vehicle compartments, etc., to regulate physical access to the vehicle. ACM 242 can also regulate access to software features and functions provided by other electronic components of the vehicle including, for example, infotainment system 204. For example, infotainment system 204 may provide access to certain content (e.g., entertainment, news, navigation information, etc.), and the access to those content can be restricted to certain privileged users/passengers. The access restriction can be enforced by ACM 242. As to be described in more details below, ACM 242 can communicate with a requester of the access and/or with a remote trusted platform (e.g., a management server) to authenticate the requester and to determine the access right of the requester.

In addition, monitoring module 244 can monitor the operation condition of the vehicle based on, for example, obtaining sensor data from external sensors 206 (e.g., LiDAR, RADAR, camera, etc.), sensor data from internal sensors 208 (e.g., hood sensor, door sensor, speed sensor, light sensor, compartment door sensor, ECU sensors (e.g., IMU, light sensor) etc.), user inputs to electronic components of the vehicle (e.g., infotainment system 204, ACM 242), whether the compartment door is open, etc. Threat mitigation module 246 can detect security and/or safety risks from the operation condition, and perform one or more operations to mitigate the security and/or safety risks. For example, threat mitigation module 246 can determine, based on the speed sensor data and LiDAR data, that there is a high risk that the vehicle will collide with an obstacle in its current trajectory, and can control ECUs 210 to automatically apply the brakes on the vehicle. As another example, threat mitigation module 246 can determine that an attempt to open the cabin door is detected based on ACM 242 and the passenger cabin door sensor data, and that the person seeking to open the cabin door is not authorized to access the cabin. In such situations, threat mitigation module 246 can control actuators 212 to, for example, lock the cabin door. OTA update module 248 can receive update information from a remote server (e.g., a management service server) to update, for example, rules and patterns for security/safety threat detection.

In addition, vehicle electronic system 200 can include wireless interface 214 to perform long-range and short-range communication to support safety and/or security management operations. For example, wireless interface 214 may include long-range communication interface, such as a cellular modem, to transmit operation data (e.g., collected by monitoring module 244) to a remote management server, and to receive instructions from the remote management server to enable or disable accesses to various components of the vehicle. As another example, wireless interface 214 may include a short-range communication interface, such as Bluetooth, Near Field Communication (NFC), etc., to receive an access request from a mobile device for accessing the software and/or hardware components of the vehicle (e.g., vehicle compartment, infotainment system 204, etc.), and forward to access request as well as credential information to ACM 242.

### Examples of a Vehicle Compartment Security System

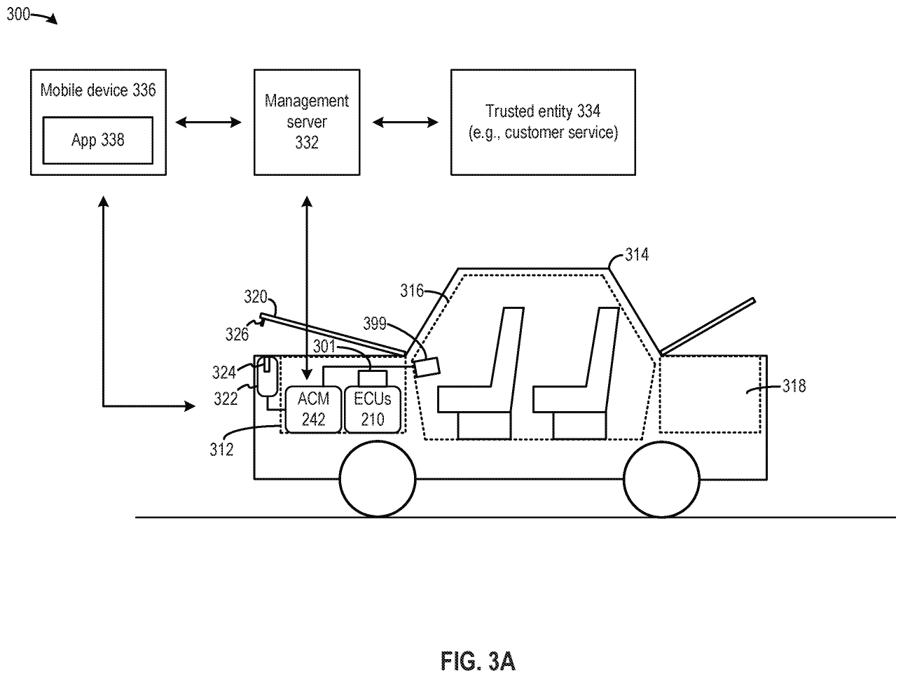

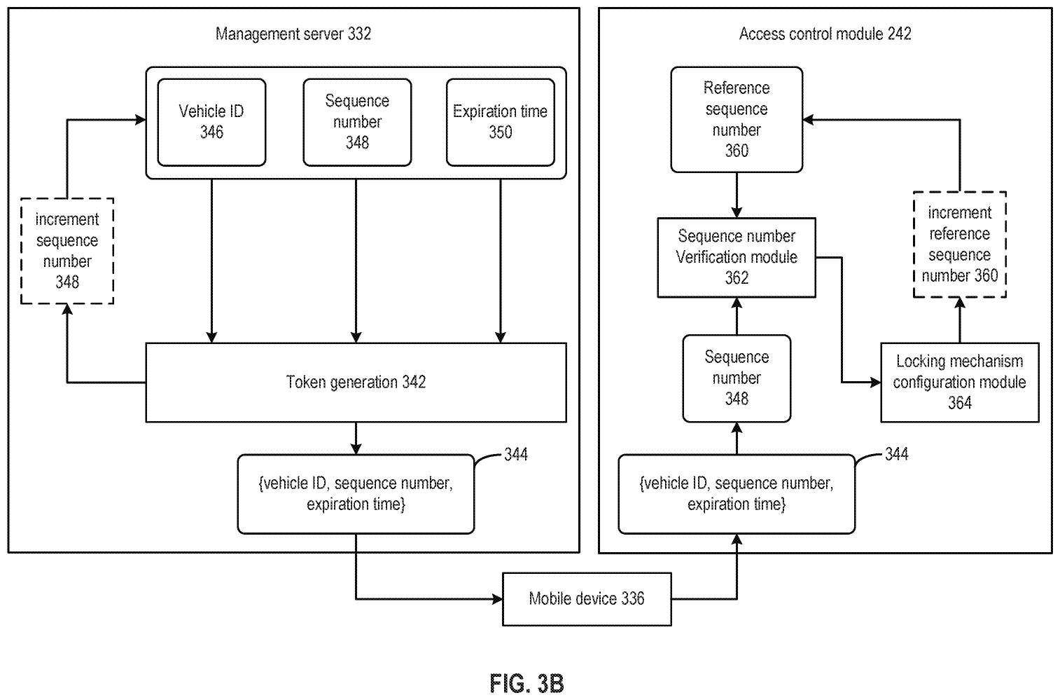

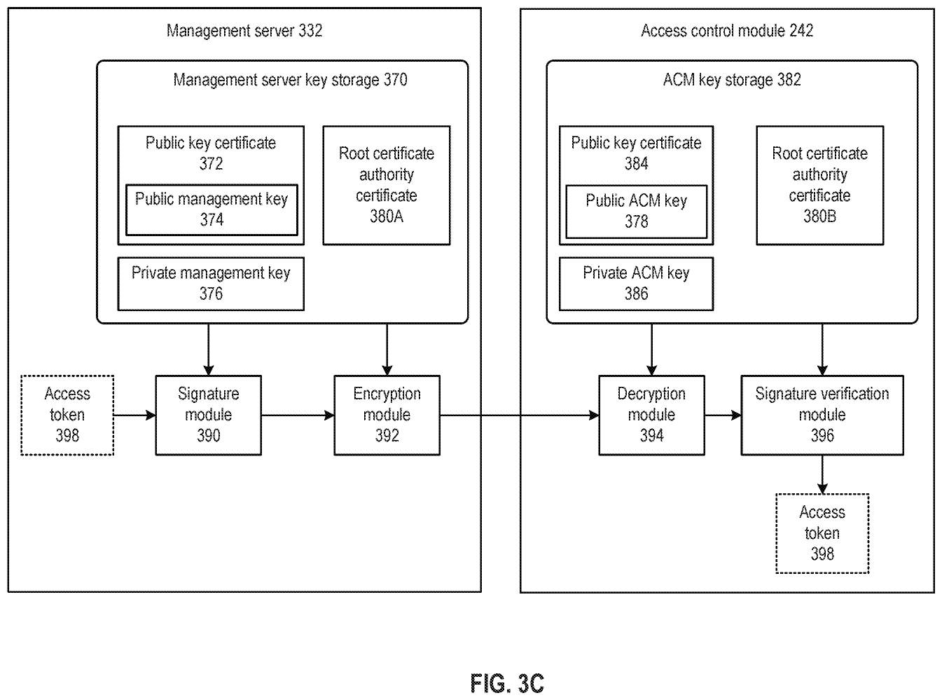

FIGS. 3A, 3B, and 3C illustrate examples of vehicle compartment security system 300, according to certain embodiments. Vehicle compartment security system 300 can be part of security and safety platform 100 to control access to a vehicle compartment 312 of a vehicle 314, which can be an autonomous driving vehicle. Vehicle compartment 312 houses various mechanical and hardware components of vehicle 314 including, for example, ECU(s) 210, access control module (ACM) 242, engine (not shown in FIG. 3A), etc. Vehicle compartment 312 can be separated from passenger cabin 316 and trunk (vehicle compartment) 318, and a passenger of vehicle 314 typically may not need to access vehicle compartment 312 to use vehicle 314 for transportation. Vehicle compartment 312 can be covered by a movable hood 320. During normal operation (e.g., when vehicle 314 is moving), movable hood 320 closes vehicle compartment 312 to protect the components housed within vehicle compartment 312 from external agents (e.g., water, dust, etc.). Movable hood 320 can be locked by a lock mechanism 322 during normal operation to prevent movable hood 320 from opening. Lock mechanism 322 can include various mechanical structures to perform a lock function. For example, as shown in FIG. 2, lock mechanism 322 may include a latch 324 to latch a hook 326 attached on hood 320, and the latch 324 can be locked at a fixed position during normal operation to prevent the opening of hood 310. Lock mechanism 322 can be disabled to unlock latch 324, and movable hood 320 can be moved by an actuator (e.g., a piston) to expose vehicle compartment 312. The actuator can be activated by a button (not shown in FIG. 3A), which can be a physical button within passenger cabin 316, a software button displayed by infotainment system 204, etc. As to be described in more detail below, the disabling of lock mechanism 322 can be regulated by vehicle compartment security system 300 to provide restricted access to vehicle compartment 312 for a limited group of people (e.g., privileged users such as the owner and/or the manager of vehicle 314) and/or under limited circumstances (e.g., when vehicle 314 requires repair service).

As shown in FIG. 3A, vehicle compartment security system 300 can include access control module (ACM) 242, a management server 332, and a trusted entity 334. ACM 242 can receive scope of access information from management server 332 for a requester (e.g., a passenger, an owner, a repair technician, etc.), and configure lock mechanism 322 based on the scope of access information. Management server 332 may store information indicating a current status of vehicle 314, the privilege states of users of vehicle 314, etc. The current status of vehicle 314 may indicate whether vehicle 314 has been activated in a check-in process. The privilege states may include credential information of a list of users of vehicle 314 (and other vehicles) designated as privileged users for vehicle 314, or for a group of vehicles including vehicle 314, based on predetermined privilege policies. On the other hand, a user who performs the check-in process as a renter of vehicle 314 or as a repair technician may not be privileged. Management server 332 can determine whether a requester is a privileged user based on the credential information provided by the requester and the credential information of the list of privileged users stored at management server 332. In another example, ACM (or other components of the vehicle) can store a list of privileged users and their credentials. A user can perform the check-in process at the vehicle and provide his/her credentials to allow the ACM to authenticate the user as a privilege user, and to provide the authenticated user with full and unlimited access of the vehicle compartment.

Management server 332 can determine the scope of access information based on the current status and privilege determination. For example, management server 332 can determine that no access shall be provided if vehicle 314 is not activated. Management server 332 can also determine full and unlimited access is to be provided if a requester for the access is a privileged user, and if vehicle 314 is activated. Management server 332 can transmit a full-access token to ACM 242 which can disable lock mechanism 322 based on receipt of the full-access token. In such a case, a requester can access vehicle compartment 312 by activating a button (e.g., within passenger cabin 316) without making a request to disable lock mechanism 322.

In some cases, management server 332 may also receive the scope of access information from trusted entity 334. Trusted entity 334 may include, for example, customer service, an administrator (and/or manager) of management server 332, etc., which can store operation information to verify whether a request to access vehicle compartment 312 is legitimate and should be granted for a requester who is not a privileged user. The operation information may include, for example, an event log of vehicle 314 (e.g., whether the vehicle has been towed to a repair shop), a current status of vehicle (e.g., whether the vehicle is in a disabled state), access policies, etc. In some cases, trusted entity 334 can determine scope of access for the requester based on the operation information, and transmit the scope of access information to management server 332, which may then forward the scope of access information to ACM 242.

For example, a repair technician may seek to gain access to vehicle compartment 312 to perform repair work. The repair technician may transmit a request including a vehicle identifier of vehicle 314 to trusted entity 304 to access the compartment. Trusted entity 304 may search the event log based on the vehicle identifier and determine that vehicle 314 is at a repair shop based on the event log and that the request is received from the repair shop. Trusted entity 304 may then determine that the request is legitimate, and can grant full and unlimited access to vehicle compartment 312. Trusted entity 304 can instruct management server 332 to generate data indicating full and unlimited access to vehicle compartment 312 (e.g., in the form of a full-access token) of vehicle 314. The data may also include the vehicle identifier of vehicle 314. Management server 332 can generate the unlimited access token and transmit the full-access token including the vehicle identifier of vehicle 314 to ACM 242, which can disable lock mechanism 322 based on receipt of the full-access token, and based on verifying that the full-access token is targeted at vehicle 314 (e.g., based on the vehicle identifier included with the token). ACM 242 can maintain lock mechanism 322 in a disabled state until, for example, receiving a second instruction from management server 332 to revoke the full and unlimited access granted to the requester (e.g., when the repair work completes).

In addition, mobile device 336 can be operated by the requester (e.g., an owner and/or a manager of vehicle 312, a passenger of the vehicle, a repair technician, etc.) and can store credential information of the requester including, for example, an identifier of the requester, password, etc. Mobile device 336 can provide the credential information to management server 332, which can determine the scope of access information based on the credential information for ACM 242. Moreover, mobile device 336 can also provide credential information of the requester to ACM 242, which can also determine the scope of access of the requester based on the locally-stored credential information and list of privileged users. In both cases, ACM 242 can configure lock mechanism 322 to provide the scope of access of vehicle compartment 312 to the requester without communicating with management server 332.

As an illustrative example, ACM 242 may lose long-range communication with management server 332 (e.g., due to the malfunction of the cellular modem of the vehicle), but ACM 242 can communicate with mobile device 336 (and App 338) using short-range communication protocols such as Bluetooth and NFC. Prior to communicating with ACM 242, App 338 can transmit a request to access vehicle compartment 312 of vehicle 314 to management server 332. The request may include credential information of the requester (e.g., a user name associated with a passenger requester, an indication that the requester is a repair technician, etc.), as well as a vehicle identifier of vehicle 314. Management server 332 can determine the scope of access based on the credential information, as well as a current status of the vehicle. For example, if the credential information indicates that the requester is a privileged user (e.g., an owner and/or a manager of vehicle 314, etc.), and the vehicle is activated by the check-in process, management server 332 can determine that the requester is to have full and unlimited access to vehicle compartment 312. Further, in a case where the credential information indicate that the requester is not a privileged user (e.g., a passenger, a repair technician, etc.), management server 332 can communicate with trusted entity 334 to determine the scope of access. For example, in a case where the requester is a repair technician, and upon determining that the request is legitimate based on the event log, trusted entity 334 may determine to grant a full and unlimited access to vehicle compartment 312 to the requester. In both cases, management server 332 can transmit the full-access token including the vehicle identifier to App 338, which can transmit the full-access token to ACM 242 via short-range communication. ACM 242 can disable lock mechanism 322 based on receipt of the full-access token and based on verifying that the full-access token is targeted at vehicle 314 (e.g., based on the vehicle identifier).

Moreover, in a case where the requester is a non-contracted repair technician (or other non-privileged users), trusted entity 334 may determine that the request poses little safety and/or security risk, and may grant a one-time and time-limited access to vehicle compartment 312 to the requester. In such a case, management server 332 can generate a temporary access token which include access scope information. The access information may indicate, for example, the access is one-time only, as well as an expiration time of the access. Management server 332 can transmit the temporary access token including the vehicle identifier to App 338, which can transmit the temporary access token to ACM 242 (e.g., via short-range communication). ACM 242 can disable lock mechanism 322 based on receipt of the temporary access token until the expiration time arrives. On the other hand, if trusted entity 334 receives information from, for example, threat intelligence source 120 of FIG. 1, which indicates that vehicle 314 is under threat, trusted entity 334 may also deny the non-privileged user access to vehicle compartment 312.

In a case where ACM 242 enables lock mechanism 322 to deny the requester access to vehicle compartment 312, ACM 242 may perform additional actions to secure vehicle compartment 312. For example, ACM 242 may detect unauthorized physical access to the interior of vehicle compartment 312. ACM 242 may also detect unauthorized physical access to the components housed within vehicle compartment 312. ACM 242 can then perform one or more operations to deter the unauthorized access, or at least to mitigate the loss caused by the unauthorized access. In some examples, the operations can be defined based on policies included in risk management policy storage 126, transportation asset management policy 132, security operation storage module 136, etc., of security and safety platform 100 of FIG. 1. In some examples, the policies, as well as the definitions of the operations, can also be locally stored in ACM 242, which can then determine the operations even if the communication with security and safety platform 100 is lost.

There are various ways by which ACM 242 may detect unauthorized physical access to vehicle compartment 312. For example, movable hood 320 may include a motion sensor. Vehicle compartment 312 may also include a light sensor. As movable hood 320 moves to expose vehicle compartment 312. The movement of movable hood 320 can be detected by the motion sensor, whereas the exposure of vehicle compartment 312 can be detected by the light sensor. If ACM 242 enables lock mechanism 322 but detects that vehicle compartment 312 is exposed based on the motion sensor and/or light sensor output, ACM 242 may determine that unauthorized physical access to vehicle compartment 312 is underway. Further, some or all of the components installed within vehicle compartment 312 (e.g., ECUs 210) can include a motion sensor. ACM 242 may detect movement of the components based on the motion sensor data and determine that unauthorized physical access to vehicle compartment 312 is underway.

ACM 242 may perform one or more operations based on detection of the unauthorized physical access. For example, ACM 242 may control a camera installed in the vehicle and facing vehicle compartment 312 to capture a picture of the intruder who accesses the vehicle compartment. As another example, ACM 242 may also notify other entities (e.g., the management, the local law enforcement, etc.) about the unauthorized access. Further, ACM 242 may also control an alarm of the vehicle to output loud alarm sound to deter the intruder.

In some embodiments, vehicle 314 may include an access element 399, which can be a user accessible control (e.g., physical button or switch, “soft” button on a display, etc.) that, in response to being activated (e.g., depressed by a user), can enable and disable access to one or more vehicle compartments (312, 318) and/or one or more vehicle components (e.g., ECU 210). Access element 399, or “button” 399, can be disposed in the cabin 316 or other suitable location. In some cases, access element 399 may be controlled by ACM 242, or other suitable module, processor(s), or the like, whether local and/or external (e.g., management server 332) to vehicle 314. In some embodiments, access element 399 may toggle between enabling and disabling a locking mechanism (322) for a vehicle compartment. Alternatively or additionally, access element 399 may toggle access to one or more vehicle components (e.g., ECU 210) by enabling and disabling an alarm system configured to trigger upon detection of an unauthorized access to the one or more vehicle components.

In some embodiments, ACM 242 may include a flag indicating whether access element 399 is be enabled based on user privileges. For example, if a user is determined to have privileges (e.g., approved credentials for an owner, repair shop, or the like), the flag may be set to indicate that access element 399 is enabled (e.g., a first mode of operation), such that pressing the access element may unlock a locking mechanism (324) so that a vehicle compartment (312) can be opened. If the user is determined not to have privileges (e.g., non-approved credentials (e.g., passenger) or no credentials (e.g., intruder)), the flag may be set to indicate that access element 399 is disabled (e.g., a second mode of operation) such that pressing the access element does nothing. In a non-limiting example, a user may check into vehicle 314 (e.g., using mobile phone to check into the vehicle via NFC), and a controller (e.g., ACM 242) may check if the user has the privilege to open certain vehicle compartments (e.g., hood 320, trunk 318). If the user is a passenger (e.g., non-owner), ACM 242 may disable the access element from functioning. If the user is a privileged user that has the privilege to open the hood lock at any time (e.g., the owner of the vehicle), the controller may enable the access element for operation. In another scenario, a user (e.g., repair person) can request from a server (e.g., management server 332) to send a command to the controller to enable the access element directly. In some cases, once a user checks out (e.g., owner leaves the car, repair shop owner returns car to owner, etc.), the access element may default to a disabled condition. In certain embodiments, privileges may be different for each user. For instance, a first user may have access privileges to a set of ECUs, while a second user may have access to a different set of ECUs, or perhaps a subset of the set of ECUs accessible by the first user. One of ordinary skill in the art with the benefit of this disclosure would appreciate the many modifications, variations, and alternative embodiments thereof.

In certain embodiments, one or more sensors (301) may be configured to detect when a vehicle compartment is breached (opened) and/or one or more vehicle components are tampered with. For example, one or more motion sensors (e.g., IMU) can be used to detect when a vehicle compartment is opened (e.g., detects hood 320 movement). Alternatively or additionally, motion sensor(s) (301) may detect when a vehicle component (e.g., ECU 210) is moved or tampered with due to a physical movement, vibrations, or the like. Motion sensors can include an inertial measurement unit (IMU), or other suitable motion detection solution. In some cases, optical sensors (e.g., optoelectronic, LED reflective) may be alternatively or additionally employed to detect, e.g., changes in an ambient light intensity within the compartment, or other suitable type, that can detect an unauthorized access to the vehicle compartments and/or vehicle components, as described above. One of ordinary skill in the art with the benefit of this disclosure would understand the many variations, modifications, and alternative embodiments thereof.

FIG. 3B illustrates an example of generation and processing of temporary access tokens between management server 332 and access control module (ACM) 242. Management server 332 may include a token generation module 342, which can generate a temporary access token 344. Management server 332 can transmit temporary access token 344 to mobile device 336 in response to receiving a compartment access request from mobile device 336, which can then transmit temporary access token 344 to ACM 242 to access vehicle compartment 312 in a case when, for example, ACM 242 loses communication with management server 332, as described above.

As shown in FIG. 3B, temporary access token 344 may include a vehicle identifier 346 (vehicle ID) and an optional sequence number 348 to enforce one-time temporary access. Temporary access token 344 may also include other information including, for example, a set of compartment identifiers and their associated scopes of access (e.g., full access, limited access, one-time or limited-times access, etc.), which may include expiration time information 350. The vehicle identifier allows ACM 242 to verify that the it is the intended recipient of the temporary access token, for example, by comparing vehicle identifier 346 against a reference vehicle identifier of the vehicle that includes ACM 242. In addition, expiration time information 350 indicates when temporary access token 344 expires. Expiration time information 350 can be in various formats. For example, expiration time information 350 can include a date and a time of expiration. ACM 242 can maintain a clock that tracks a current date and a current time at vehicle 314. ACM 242 can disable lock mechanism 322 until the current date and time, indicated by the clock, match the date and time of expiration. As another example, expiration time information 350 may also include an expiration count value. ACM 242 can start a counter when the disabling of lock mechanism 322 starts. The disabling of lock mechanism 322 can stop when the counter value reaches the expiration count value. In some embodiments, ACM 242 can maintain a second counter that counts a number of times the expiration count value has been reached, which indicates a number of times access has been granted to a particular vehicle compartment. The second counter can be used to enforce a limited-times access where the user is allowed to access the vehicle compartment for a limited number of times, with the duration of each access being governed by expiration time information 350 and monitored by the first counter.

In addition, as described above, temporary access token 344 may be used for a one-time access. After the current temporary access token expires or is used, the requester must present a new temporary access token to access vehicle compartment 312 again. There are various ways by which ACM 242 can enforce an one-time access policy. For example, ACM 242 can maintain a secure clock which not only tracks the current date and time but is also secure against tampering. ACM 242 can accept a temporary access token and disable lock mechanism 322 only if the current date and time precede the expiration time and date of the temporary access token. ACM 242 can also delete the temporary access token when the token expires. With such an arrangement, the risk of ACM 242 providing access vehicle compartment 312 based on accepting an expired token can be mitigated.

In some examples, ACM 242 can also enforce the one-time access policy by tracking a state of temporary provision of compartment access. The state can be tracked based on sequence number 348 included in temporary access token 344. More specifically, management server 332 can store sequence number 348 included in the most recent temporary access token (e.g., temporary access token 344), and can increment sequence number 348 for the next temporary access token. Moreover, ACM 242 can store a reference sequence number 360 extracted from the last temporary access token received by ACM 242. ACM 242 further includes sequence number verification module 362 to verify that a new temporary access token has been received. For example, sequence number verification module 362 can compare reference sequence number 360 against sequence number 348 extracted from temporary access token 344. If reference sequence number 360 is below sequence number 348, ACM 242 can determine that temporary access token 344 is a new access token, rather than an expired access token, and can control locking mechanism configuration module 364 to disable lock mechanism 322. After temporary access token 344 expires, ACM 242 can remove temporary access token 344 and increment reference sequence number 360 to match sequence number 348, such that reference sequence number 360 reflects the sequence number extracted from the last temporary access token received by ACM 242, in this case temporary access token 344.

In some embodiments, to further improve security, a secure communication channel can be established between different components of vehicle compartment security system 300 for secure transmission of access tokens. For example, a secure communication channel, such as a Transport Layer Security (TLS) session, can be established between ACM 242 and management server 332, and between mobile device 336 and ACM 242. Mutual authentication can take place between ACM 242 and management server 332, and between mobile device 336 and ACM 242, before the respective secure communication channel is established. The mutual authentication enables mobile device 336 and ACM 242 to verify that they are receiving an access token from a trusted issuer of the access token. Moreover, management server 332 can also verify that mobile device 336 and ACM 242 are trusted devices and are allowed to receive the access token from management server 332. In addition, management server 332 can sign the access token using a management key owned by management server 332 and optionally then encrypt the access token with the signature. The optional encryption can be performed using, for example, a public key of ACM 242, a shared symmetric key, etc. The access token can be sent to ACM 242, which can include the corresponding private key or shared symmetric key to perform the decryption of the access token. All these can mitigate the risks of, for example, a malicious user using a fake access token not procured from management server 332, or an access token intercepted from management server 332, to obtain unauthorized access to vehicle compartment 312.

FIG. 3C illustrates an example of a secure transmission of an access token from management server 332 to access control module (ACM) 242, according to certain embodiments. As shown in FIG. 3C, management server 332 includes a management server key storage 370 that stores a public key certificate 372 which includes a public management key 374, and a private management key 376, all of which are associated with management server 332. Management server key storage 370 further stores a root certificate authority certificate 380, which can be used to verify ACM 242's certificate. In some examples, management server 332 can receive the keys in a provisioning process before vehicle 312 is made available for transportation operations.

In addition, ACM 242 includes ACM key storage 382 that stores a public key certificate 384 of ACM 242. Public key certificate 384 further includes public ACM key 378. Further, ACM key storage 382 also stores a private ACM key 386, and a root certificate authority certificate 380B, which can be used to verify management server 332's certificate. Management server 332 further includes a signature module 390 and an encryption module 392, whereas ACM 242 includes a decryption module 394 and a signature verification module 396.

As part of a mutual authentication process to establish a secure communication channel (e.g., a TLS session), management server 332 can transmit its public key certificate 372 to ACM 242, whereas ACM 242 can transmit its public key certificate 384 to management server 332. Public key certificate 372 of management server 332 can be verified by a public key included in root certificate authority certificate 380B of ACM 242, whereas public key certificate 384 of ACM 242 can be verified by a public key included in root certificate authority certificate 380A of management server 332. For example, management server 332 can authenticate ACM 242 based on verifying that public key certificate 384 is signed with a key from an ACM root certificate authority defined in root certificate authority certificate 380A, and based on the content of public key certificate 384 (e.g., public key certificate 384 including an identifier of a trusted ACM). Further, ACM 242 can authenticate management server 332 based on verifying that public key certificate 372 is signed with a key from a Management Server root certificate authority defined in root certificate authority certificate 380B, and based on the content of public key certificate 372 (e.g., public key certificate 372 including an identifier of a trusted management server). Upon successful authentication, management server 332 can extract public ACM key 378 from public key certificate 384. Further, ACM 242 can extract public management key 374 from public key certificate 372 and (optionally) store public management key 374 at ACM key storage 382.

To perform secure transmission of an access token 398 (which may include, for example, a vehicle identifier, and in some cases, access scope information including a sequence number, expiration time information, etc.), management server 332 can control signature module 390 to sign access token 398 using private management key 376. Management server 332 can also control encryption module 392 to encrypt the signed access token using public ACM key 378 (e.g., extracted from public key certificate 384), or a shared symmetric key (e.g., exchanged during TLS session establishment). Management server 332 can then transmit the signed and encrypted access token 398 to ACM 242. ACM 242 can control decryption module 394 to decrypt the received access token using private ACM key 386. ACM 242 can also control signature verification module 396 to verify the signature of the decrypted access token 398 using public management key 374 (e.g., extracted from public key certificate 372) or using a symmetric key, to ensure that access token 398 is received from the authenticated management server 332. ACM 242 also verifies that the access token is intended to ACM 242 based on the vehicle identifier included in the access token. Upon verifying the signature, the vehicle identifier, and other information (e.g., vehicle compartment identifier), ACM 242 can control locking mechanism configuration module 364 (not shown in FIG. 3C) to provide access to vehicle compartment 312 based on the access scope information included in access token 398.

Although FIG. 3C illustrates an example of secure transmission of access token from management server 332 to ACM 242, it is understood that the example of secure transmission can also be performed between management server 332 and mobile device 336. For example, mobile device 336 can also store a public key certificate including a public key of mobile device 336, and Management Server root certificate authority certificate 380A. Management server 332 and mobile device 336 can perform mutual authentication based on the techniques described above, and mobile device 336 can receive the encrypted and signed access token 398 from management server 332. Mobile device 336 can decrypt the access token then transmit the decrypted and signed access token 398 to ACM 242, which can verify the signature of access token 398 using management server 332's certificate and provide access to vehicle compartment 312. In some examples, mobile device 336 may receive or generate the management key and perform mutual authentication with ACM 242 using the management key.

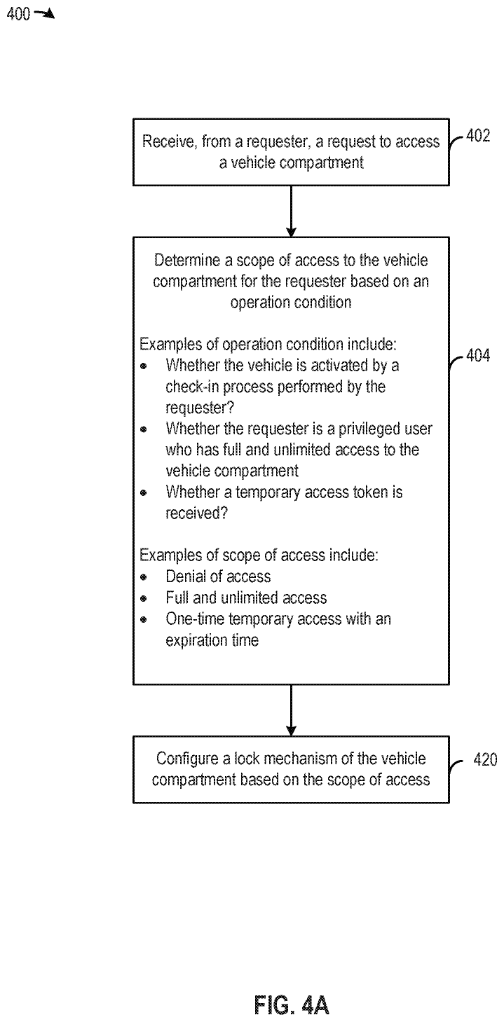

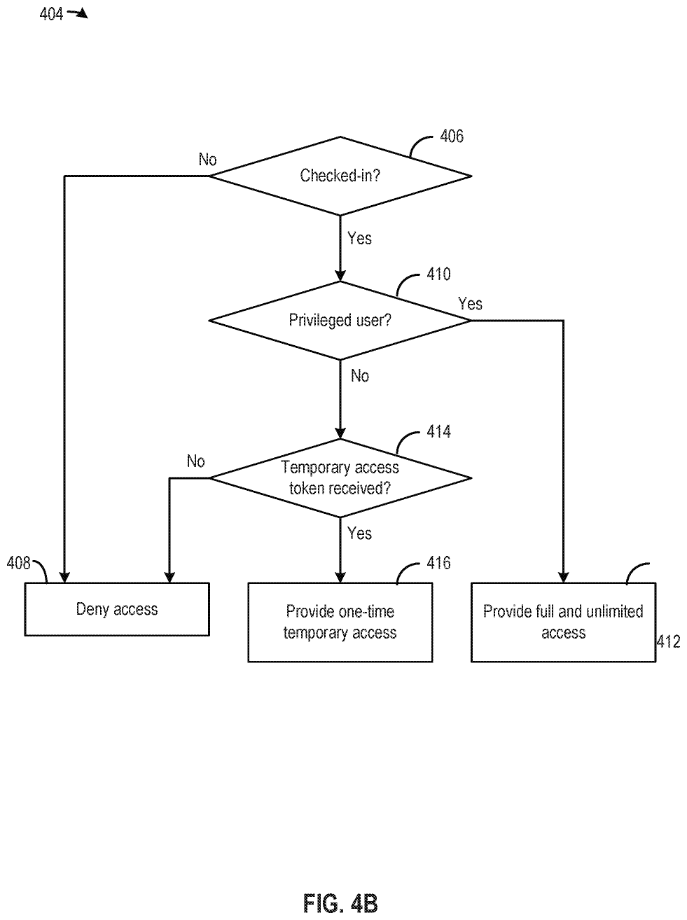

FIG. 4A and FIG. 4B show a simplified flow diagram of method 400 for controlling the access to a vehicle compartment (e.g., vehicle compartment 312), according to certain embodiments. Method 400 may be performed by processing logic that may comprise hardware (circuitry, dedicated logic, etc.), software operating on appropriate hardware (such as a general purpose computing system or a dedicated machine), firmware (embedded software), or any combination thereof. In certain embodiments, method 400 can be performed by vehicle compartment security system 300 of FIG. 3A-FIG. 3C.

Referring to FIG. 4A, at operation 402, the system may receive, from a requester, a request to access a vehicle compartment. There are various ways by which the system can receive the request. In some cases, the request can be sent to Management Server while the user is trying to check in. The ACM can determine whether to enable the soft button for opening the compartment while the user checks in. In another example, an access control module (e.g., ACM 242) at the vehicle can receive the request based on detecting the activation of an actuator (e.g., a physical button, a software button, etc.) to open the hood that covers the vehicle compartment. As another example, a management server of the system (e.g., management server 332) can also receive the request from a mobile device, from a customer service server operated by a trusted entity, etc. The requester may include, for example, an owner/manager of the vehicle, a passenger of the vehicle, a repair technician, or any person.

At operation 404, the system may determine a scope of access to the vehicle compartment for the requester based on an operation condition. Examples of the operation condition may include, for example, whether the vehicle is activated by a check-in process performed by the requester, whether the requester is a privileged user who has full and unlimited access to the vehicle compartment, whether a temporary unlock instruction is received, etc. Examples of scope of access may include, for example, denial of access, full and unlimited access, one-time temporary access with an expiration time, etc.

FIG. 4B illustrate an example of operations included in operation 404 to determine a scope of access to the vehicle compartment for the requester based on an operation condition, according to certain embodiments. As shown in FIG. 4B, at operation 406, the system may determine whether the requester has activated the vehicle via a check-in process at the management server. If no check-in process has been performed, the system may deny the requester access to vehicle compartment 312, at operation 408.

On the other hand, if a check-in process has been performed, the system may determine whether the requester is a privileged user, at operation 410. The determination can be based on comparing the credential information provided by the requester against a list of users designated as privileged users including, for example, the owner and/or the manager of the vehicle. If the requester is a privileged user, the system may provide full and unlimited access to vehicle compartment 312, at operation 412.

Moreover, if the requester is not a privileged user, the system (e.g., the ACM) may determine whether a temporary access token has been received (e.g., from management server), at operation 414. As described above, a management server may issue a temporary access token to a requester based on an instruction from a trusted entity, and the temporary access token may enable a one-time temporary access with an expiration time. If the ACM receives the temporary access token, the system may provide the one-time temporary access to vehicle compartment 312, at operation 416. If the ACM does not receive the temporary access token, the system may deny the requester access to vehicle compartment 312, at operation 408.

Referring back to FIG. 4A, at operation 420 the system may configure a lock mechanism (or access element to control the lock mechanism) of the vehicle compartment based on the scope of access determined at operation 404. The configuration may include, for example, enabling the lock mechanism to deny the requester access, disabling the lock mechanism to provide the requester full and unlimited access, or disabling the lock mechanism until the expiration time arrives to provide the requester temporary access. The system may perform additional operations to enforce one-time temporary access and/or to detect unauthorized access to the vehicle compartment, as described above with respect to FIG. 3A and FIG. 3B.

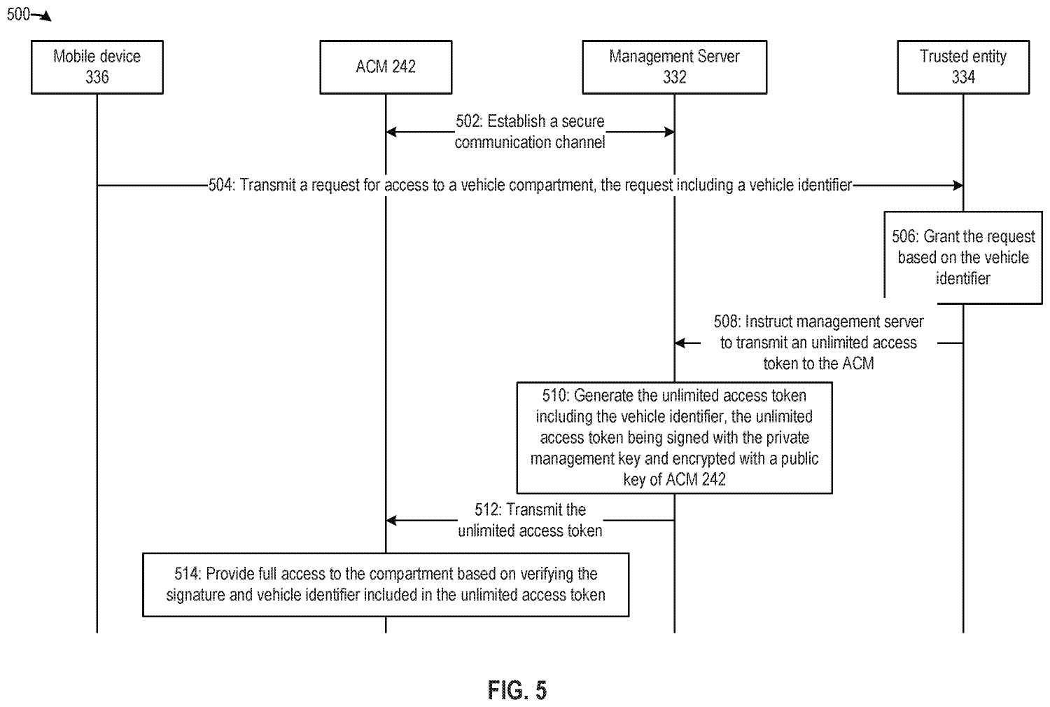

FIG. 5 shows a simplified flow diagram of method 500 for controlling the access to a vehicle compartment (e.g., vehicle compartment 312), according to certain embodiments. Method 500 may be performed by processing logic that may comprise hardware (circuitry, dedicated logic, etc.), software operating on appropriate hardware (such as a general purpose computing system or a dedicated machine), firmware (embedded software), or any combination thereof. In certain embodiments, method 500 can be performed by vehicle compartment security system 300 of FIG. 3A-FIG. 3C including mobile device 336, ACM 242, management server 332, and trusted entity 334. In this example, mobile device 336 may be operated by a repair technician, whereas trusted entity 334 can be operated by customer service.

At operation 502, ACM 242 and management server 332 may establish a secure communication channel based on, for example, exchanging public key certificates, as described in FIG. 3C. As part of the exchanging of public key certificates, management server 332 can also transmit its public management key (e.g., public management key 374 of FIG. 3C) to ACM 242. Management server 332 also receives public key of ACM 242. The secure communication channel may include, for example, a TLS session. Mutual authentication between ACM 242 and management server 332 also takes place at operation 502.

At operation 504, mobile device 336, operated by the repair technician, may transmit a request for access to a vehicle compartment to trusted entity 334. The request may include a vehicle identifier of the vehicle having the vehicle compartment.

At operation 506, trusted entity 334 may grant the request based on the vehicle identifier included in the request. For example, as described above, trusted entity 334 may refer to an event log and determine that a vehicle having the vehicle identifier is towed to a repair shop, and determine that the request to access the vehicle compartment is legitimate.

At operation 508, trusted entity 334 may transmit an instruction to management server 332 to transmit an unlimited access token to ACM 242, based on determining that the access request is legitimate at operation 506.

At operation 510, management server 332 may generate the unlimited access token including the vehicle identifier. Management server 332 may also sign the unlimited access token using its private management key and encrypt the signed access token with a public key of ACM 242, as described with respect to FIG. 3C.

At operation 512, management server 332 may transmit the encrypted and signed access token to ACM 242 via the secure communication channel established in operation 502.

At operation 514, ACM 242 may decrypt the token and verify the signature and the vehicle identifier and other information (e.g., expiration or sequence number) included in the unlimited access token and, based on the verification, provide the requester with full and unlimited access to the vehicle compartment.

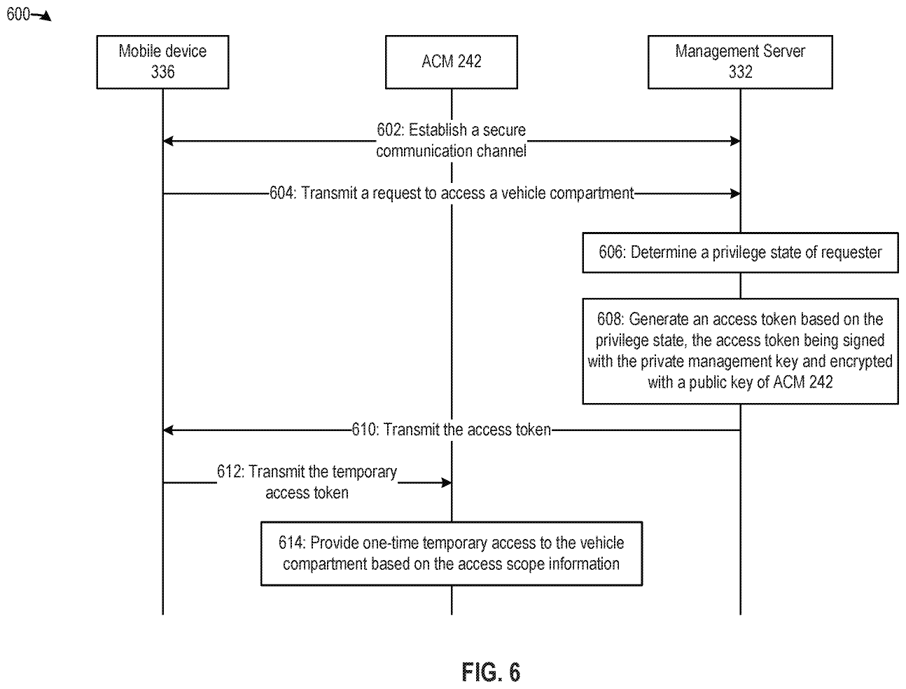

FIG. 6 shows a simplified flow diagram of method 600 for controlling the access to a vehicle compartment (e.g., vehicle compartment 312), according to certain embodiments. Method 600 may be performed by processing logic that may comprise hardware (circuitry, dedicated logic, etc.), software operating on appropriate hardware (such as a general purpose computing system or a dedicated machine), firmware (embedded software), or any combination thereof. In certain embodiments, method 600 can be performed by certain components of vehicle compartment security system 300 of FIG. 3A-FIG. 3C including mobile device 336, ACM 242, management server 332, and trusted entity 334. In this example, ACM 242 may be unable to communicate with management server 332 temporarily (e.g., no cellular access), but can communicate with mobile device 336 using a short-range communication protocol including, for example, Bluetooth, NFC, Wi-Fi, ZigBee, unlicensed LTE, Infra-red communication, Quick Response (QR) code scan, image scan, etc.

At operation 602, ACM 242 and mobile device 336 may establish a secure communication channel based on, for example, exchanging public key certificates, as described in FIG. 3C. The secure communication channel may include, for example, a TLS session. Mutual authentication between ACM 242 and mobile device 336 also takes place at operation 602.

At operation 604, mobile device 336, operated by a requester (e.g., an owner, a passenger, etc.) may transmit a request for access to a vehicle compartment to management server 332. The request may include a vehicle identifier of the vehicle having the vehicle compartment as well as credential information of the requester.

At operation 606, management server 332 may determine a privilege state of the requester. The determination can be based on, for example, comparing the credential information in the request against the credential information of a list of privileged users.

At operation 608, management server 332 may generate an access token based on the privilege state. If the requester is a privileged user, management server 332 may generate an unlimited access token. If the requester is not a privileged user, management server 332 may communicate with trusted entity 334 (not shown in FIG. 6) to determine an access scope for the requester. Based on the input from trusted entity 334, management server 332 may generate a temporary access token including access scope information. The access scope information may include, for example, a sequence number to ensure one-time access, and expiration time information, as described in FIG. 3B. The access token is signed with the private management key of management server 332 and encrypted with a public key of ACM 242. Management server 332 may obtained the public key of ACM 242 via a prior communication session with ACM 242.

At operation 610, management server 332 may transmit the encrypted and signed access token to mobile device 336, which can store the access token. In some examples, management sever may transmit the encrypted access token to mobile device 336, which can sign the access token with a private management key.

At operation 612, mobile device 336 may transmit a request to access vehicle compartment 312, with the request including the access token obtained from management server 332.

At operation 614, ACM 242 may verify the signature and the vehicle identifier included in the unlimited access token and, if the signature is verified, provide the requester with access to the vehicle compartment according to the access scope information. For example, if an unlimited access token is received, ACM 242 may provide full and unlimited access. If a temporary access token is received, ACM 242 may provide one-time temporary access.

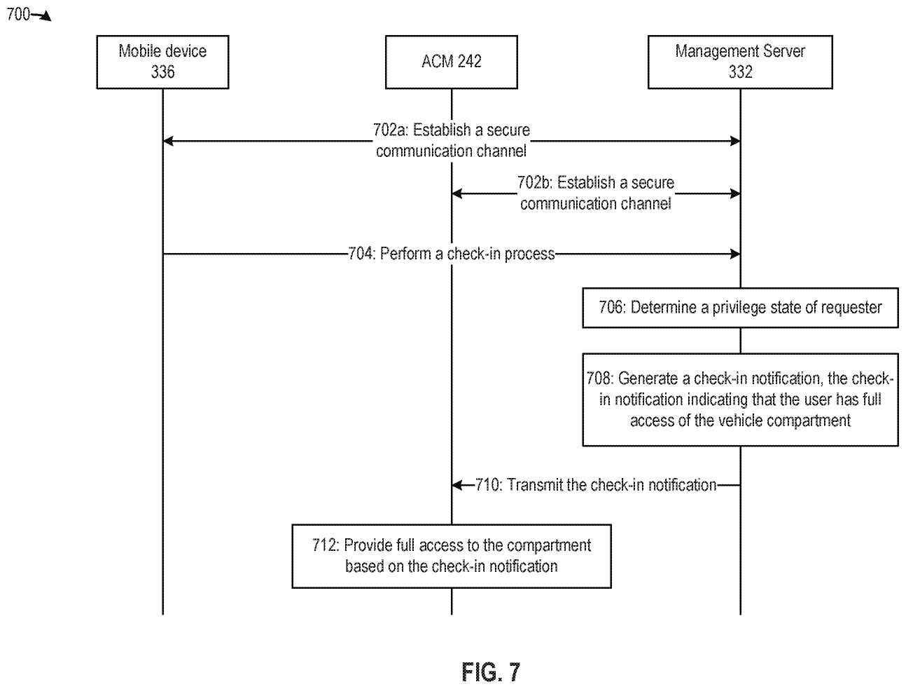

FIG. 7 shows a simplified flow diagram of method 700 for controlling the access to a vehicle compartment (e.g., vehicle compartment 312), according to certain embodiments. Method 600 may be performed by processing logic that may comprise hardware (circuitry, dedicated logic, etc.), software operating on appropriate hardware (such as a general purpose computing system or a dedicated machine), firmware (embedded software), or any combination thereof. In certain embodiments, method 700 can be performed by certain components of vehicle compartment security system 300 of FIG. 3A-FIG. 3C including mobile device 336, ACM 242, and management server 332. In this example, a user can use their mobile device perform a check-in process with management server 332 to activate a vehicle.

At operation 702a, ACM 242 and mobile device 336 may establish a secure communication channel based on, for example, exchanging public key certificates, as described in FIG. 3C. Moreover, at operation 702b, ACM 242 and management server 332 may also establish a secure communication channel based on, for example, exchanging public key certificates, as described in FIG. 3C. Each secure communication channel may include, for example, a TLS session.

At operation 704, mobile device 336, operated by a user (e.g., an owner, a passenger, etc.) may transmit a request to perform a check-in operation to activate a vehicle. The request may include credential information of the user.

At operation 706, management server 332 may determine a privilege state of the user. The determination can be based on, for example, comparing the credential information in the user against the credential information of a list of privileged users.

At operation 708, management server 332 may generate a check-in notification based on completion of the check-in process. The check-in notification may include an indication that the user is a privileged user and has full and unlimited access to vehicle compartment 312.

At operation 710, management server 332 may transmit the check-in notification to ACM 224, which can store the check-in notification. At this time, note that the TLS session may be established with mutual authentication, as addressed above.

At operation 712, management server 332 may provide full access to the compartment based on the check-in notification indicating that the user is a privileged user and has full and unlimited access to vehicle compartment 312.

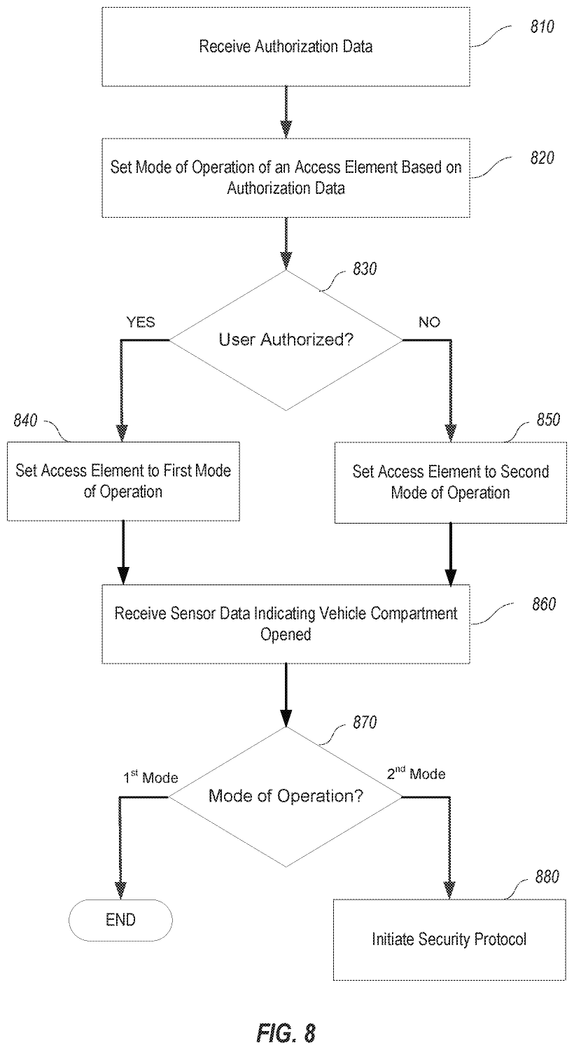

FIG. 8 shows a simplified flow diagram of method 800 for controlling the access to a vehicle compartment (e.g., vehicle compartment 312) and/or vehicle components, according to certain embodiments. Method 800 may be performed by processing logic that may comprise hardware (circuitry, dedicated logic, etc.), software operating on appropriate hardware (such as a general purpose computing system or a dedicated machine), firmware (embedded software), or any combination thereof. In certain embodiments, method 800 can be performed by vehicle compartment security system 300 of FIG. 3A-3C including mobile device 336, ACM 242, management server 332, and trusted entity 334.

At operation 810, method 800 can include receiving authorization data, according to certain embodiments. The authorization data may indicate whether a user accessing the vehicle has security privileges. This may be established by comparing credential information provided by the user against a list of users designated as privileged users, such as a vehicle owner, vehicle manager (e.g., for a fleet of vehicles), or the like. In some cases, the authorization data may contain the description of the privileges to the ECUs or ECU groups. For example, a first user (e.g., family member of owner) may have access to one subset of ECUs (e.g., infotainment systems) but not to other ECUs, while a second user (e.g., the owner) may have access to all ECUs. If the user is determined to have security privileges, they can be deemed to be authorized to access a secure location or resource, such as a vehicle compartment (e.g., hood, trunk), vehicle component (e.g., ECU), other secure resource, or a combination thereof, as described above. Furthermore, an access element (button 399) that can control the access to the secure location and/or resource may be enabled. On the other hand, if the user determined not to be a privileged user, the system (e.g., the ACM) may determine whether the user has temporary access (e.g., provides a temporary access token with an associated expiration time, as described above), such as a repair shop or a user that the owner may want to approve (e.g., family member), and authorize the user. Otherwise, the user can be determined to have no security privileges and be unauthorized for access to the secure locations and/or resources. In such cases, the access element that may be disabled. As indicated above, the access element can be a user accessible button disposed in a cabin of the vehicle and, in response to being activated, may be configured to toggle between the first mode of operation and the second mode of operation.

At operation 820, method 800 can include setting a mode of operation of an access element based on the authorization data, according to certain embodiments. In some cases, the access element can be operable to control a locking mechanism of the vehicle compartment in a vehicle. For instance, if the user is authorized (operation 830), the access element can be configured to operate in a first mode of operation that allows the access element to control the locking mechanism (operation 840). In some cases, this may include allowing a hood release latch (locking mechanism) to operate normally when the access element (button) is pressed. If the user is not authorized (operation 830), the access element can be configured to operate in a second mode of operation that prevents the access element to control the locking mechanism (operation 840). In some implementations, this may include allowing preventing a hood release latch (locking mechanism) from operating when the access element (button) is pressed.

At operation 860, method 800 can include receiving sensor data indicating that the vehicle compartment in the vehicle has been opened, according to certain embodiments. For example, a movement detection sensor (e.g., image sensor detecting movement, IMU, etc.) may detect that the hood of the vehicle has moved (i.e., has been opened). As described above, other types of sensors can be used (e.g., optical sensors, light sensors, relays, force sensors, etc.) that can detect whether a compartment has been opened. Alternatively or additionally, sensor data may further detect that a vehicle component (e.g., ECU) has been tampered with. For instance, an IMU coupled to the ECU can detect if a user is interacting with it or perhaps attempting to remove it from the vehicle. In some systems, one or more ECUs may not be disposed within a compartment. In such cases, one or more sensors (e.g., motion sensors, light sensors, etc.) can be used to detect with the ECU is removed, replaced, or otherwise tampered with. In another example, a light sensor may be coupled to an ECU (e.g., within a dark chamber on the bottom of the ECU that may be subject to changes in ambient light when the ECU is moved). As such, the same security measures described herein that pertain to access and detection of an opening of a compartment in a vehicle can alternatively or additionally be applied to access and detection of ECU tampering.

At operation 870, in response to the authorization data corresponding to the first mode of operation (e.g., the user is authorized) and the sensor data contemporaneously (e.g., at the same time) indicates that the vehicle compartment is opened and/or a vehicle component is being accessed, moved, or tampered with, the system may perform no action (e.g., the method ends) as the user is authorized to perform the detected actions. However, in response to the authorization data corresponding to the second mode of operation and the sensor data contemporaneously indicating that the vehicle compartment is opened and/or a vehicle component is being accessed, moved, or tampered with, method 800 can include initiating a security protocol (operation 880). In some cases, this may include alerting one or more security entities (e.g., the police, private security services), transmitting an alert to a vehicle fleet management server (which can be the responsible entity for providing the authorization data), or other suitable security protocol.

In embodiments employing one or more light sensors (e.g., sensor(s) 301) coupled to the ECU or in a compartment housing the ECU, the light sensor(s) can be configured to detect a change in an ambient light within a perimeter of the ECU, and the ACM can be further configured to control access to the vehicle compartment based on the light sensor contemporaneously detecting changes in the ambient light within the perimeter of the ECU that is greater than a threshold value. In some cases, changes in the ambient light may not be contemporary (e.g., it occurred within the last 1, 5, 10 minutes, or other suitable time period). In some cases, the perimeter may be any suitable area around and including the ECU. For instance, the perimeter can be a volumetric area defined by dimensions within the vehicle compartment 312 or within contours, chambers, or slots/holes, etc. of the ECU itself; defined by a range of detection of the light sensor, or a combination thereof. A threshold value can be any suitable change in detected light (typically measured in lumens, candelas, or lux), such as a change in 1, 5, 10 lumens or other suitable amount over a range of time (current, over a 10 second window, etc.).

In further embodiments, the ACM can be configured to trigger the alarm in response to the security data indicating that the user does not have a security privilege, the IMU contemporaneously detecting a movement of the ECU, and the ACM contemporaneously receiving data indicating that the vehicle is not in motion. For instance, the IMU may detect movement of the ICU while the vehicle is in motion. Alternatively or additionally, one or more additional IMUs configured on the vehicle may be used so that a difference in a motion (e.g., position/displacement, velocity, and/or acceleration) between the IMU on the ECU and the IMU(s) on the vehicle can be compared. In some cases, if the IMUs measure similar movement (e.g., displacement, acceleration, speed, etc.), this may reflect that the vehicle is simply in motion and the IMU is not being otherwise perturbed. However, if the IMUs reflect different or contrary movement (e.g., different distances relative to each other or to the vehicle, different velocities/accelerations, etc., this can be indicative of the IMU being moved and/or tampered with and not related primarily to vehicle motion. One of ordinary skill in the art with the benefit of this disclosure would understand the many variations, modifications, and alternative embodiments of utilizing sensors to detect whether a vehicle compartment has been breached/opened and/or a vehicle component has been moved, accessed, or tampered with.

It should be appreciated that the specific steps illustrated in FIG. 8 provide a particular method 800 for controlling access to a vehicle compartment and/or vehicle component, according to certain embodiments. Other sequences of steps may also be performed according to alternative embodiments. Furthermore, additional steps may be added or removed depending on the particular applications. Any combination of changes can be used and one of ordinary skill in the art with the benefit of this disclosure would understand the many variations, modifications, and alternative embodiments thereof.

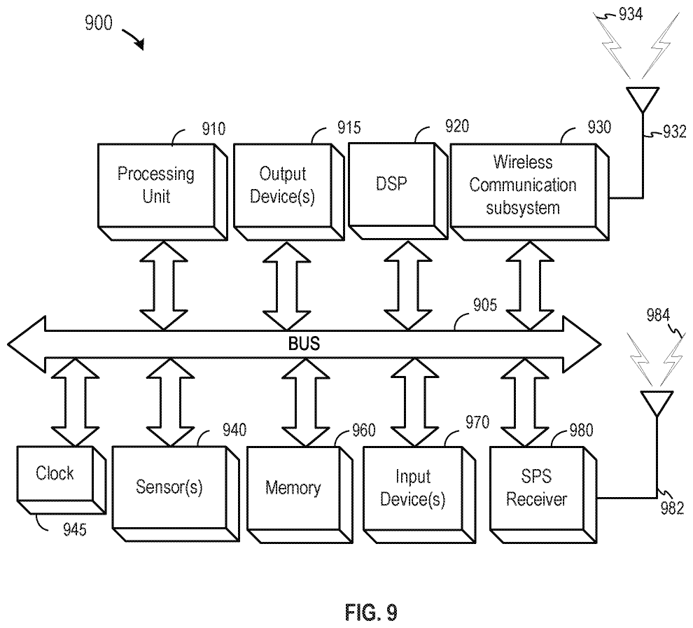

FIG. 9 a simplified block diagram of an example of a mobile device 900, such as a wireless mobile device (e.g., a smart phone, a smart watch, a touch pad, etc.), for implementing some techniques disclosed herein according to certain embodiments. For example, mobile device 900 may be used as the user device or a device in a vehicle as described above. It should be noted that FIG. 9 is meant only to provide a generalized illustration of various components, any or all of which may be utilized as appropriate. In some embodiments, for example, mobile device 900 can be a cellular telephone or other mobile electronic device. As such, as previously indicated, components may vary from embodiment to embodiment.

Mobile device 900 is shown comprising hardware elements that can be electrically coupled via a bus 905 (or may otherwise be in communication, as appropriate). The hardware elements may include a processing unit(s) 910 which can include without limitation one or more general-purpose processors, one or more special-purpose processors (such as digital signal processing (DSP) chips, graphics acceleration processors, application specific integrated circuits (ASICs), and/or the like), and/or other processing structure or means, which can be configured to perform one or more of the methods described herein. As shown in FIG. 9, some embodiments may have a separate DSP 920, depending on desired functionality. Mobile device 900 also can include one or more input devices 970, which can include without limitation a touch screen, a touch pad, microphone, button(s), dial(s), switch(es), and/or the like; and one or more output devices 915, which can include without limitation a display, light emitting diodes (LEDs), speakers, and/or the like.

Mobile device 900 might also include a wireless communication subsystem 930, which can include without limitation a modem, a network card, an infrared communication device, a wireless communication device, a near-field communication (NFC) device, and/or a chipset (such as a Bluetooth device, an International Electrical and Electronics Engineers (IEEE) 802.11 device (e.g., a device utilizing one or more of the 802.11 standards described herein), an IEEE 802.15.4 device, a Wi-Fi device, a WiMAX device, cellular communication facilities, etc.), and/or the like. Wireless communication subsystem 930 may permit data to be exchanged with a network, wireless access points, other computer systems, and/or any other electronic devices described herein. The communication can be carried out via one or more wireless communication antenna(s) 932 that send and/or receive wireless signals 934.

Depending on desired functionality, wireless communication subsystem 930 can include separate transceivers to communicate with antennas of base transceiver stations and other wireless devices and access points as described above, which may include communicating with different data networks and/or network types, such as wireless wide-area networks (WWANs), wireless local area networks (WLANs), or wireless personal area networks (WPANs). A WWAN may be a network using any air interface technology, for example, a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16), and so on. A CDMA network may implement one or more radio access technologies (RATs) such as cdma2000, W-CDMA, and so on. Cdma2000 includes IS-95, IS-2000, and/or IS-856 standards. A TDMA network may implement GSM, Digital Advanced Mobile Phone System (D-AMPS), or some other RATs. An OFDMA network may employ LTE, LTE Advanced, and so on. LTE, LTE Advanced, GSM, and W-CDMA are described in documents from 3GPP. Cdma2000 is described in documents from a consortium named “3rd Generation Partnership Project 2” (3GPP2). 3GPP and 3GPP2 documents are publicly available. A WLAN may be an IEEE 802.11x network. A WPAN may be a Bluetooth network, an IEEE 802.15x, or some other type of network. The techniques described herein may also be used for any combination of WWAN, WLAN and/or WPAN.

Mobile device 900 may include a clock 945 on bus 905, which can generate a signal to synchronize various components on bus 905. Clock 945 may include an inductor-capacitor (LC) oscillator, a crystal oscillator, a ring oscillator, a digital clock generator such as a clock divider or clock multiplexer, a phase locked loop, or other clock generator. Clock 945 may be synchronized (or substantially synchronized) with corresponding clocks on other wireless devices. Clock 945 may be driven by wireless communication subsystem 930, which may be used to synchronize clock 945 of mobile device 900 to one or more other devices. Clock 945 may be used for timing measurement.

Mobile device 900 can further include sensor(s) 940. Such sensors can include, without limitation, one or more accelerometer(s), gyroscope(s), camera(s), magnetometer(s), altimeter(s), microphone(s), proximity sensor(s), light sensor(s), touch sensor(s), RF sensor(s), audio sensor(s), and the like.

Embodiments of the mobile device 900 may also include an SPS receiver 980 capable of receiving signals 984 from one or more SPS satellites using an SPS antenna 982. Signals 984 may be used to determine a location of mobile device 900, for example, for navigating the autonomous vehicle. SPS receiver 980 can extract a position of the mobile device 900, using conventional techniques, from SPS satellite vehicles (SVs) of an SPS system, such as global navigation satellite system (GNSS) (e.g., Global Positioning System (GPS)), Galileo, Glonass, Compass, Quasi-Zenith Satellite System (QZSS) over Japan, Indian Regional Navigational Satellite System (IRNSS) over India, Beidou over China, and/or the like. Moreover, SPS receiver 980 can use various augmentation systems (e.g., a Satellite Based Augmentation System (SBAS)) that may be associated with or otherwise enabled for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Thus, as used herein, an SPS system may include any combination of one or more global and/or regional navigation satellite systems and/or augmentation systems, and SPS signals may include SPS, SPS-like, and/or other signals associated with one or more such SPS systems.

Mobile device 900 may further include and/or be in communication with a memory 960. Memory 960 may include any non-transitory storage device, and may include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

Memory 960 of mobile device 900 also can comprise software elements (not shown), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the functionality discussed above. In an aspect, such code and/or instructions can be used to configure and/or adapt a general purpose computer (or other device) to perform one or more operations in accordance with the described methods.

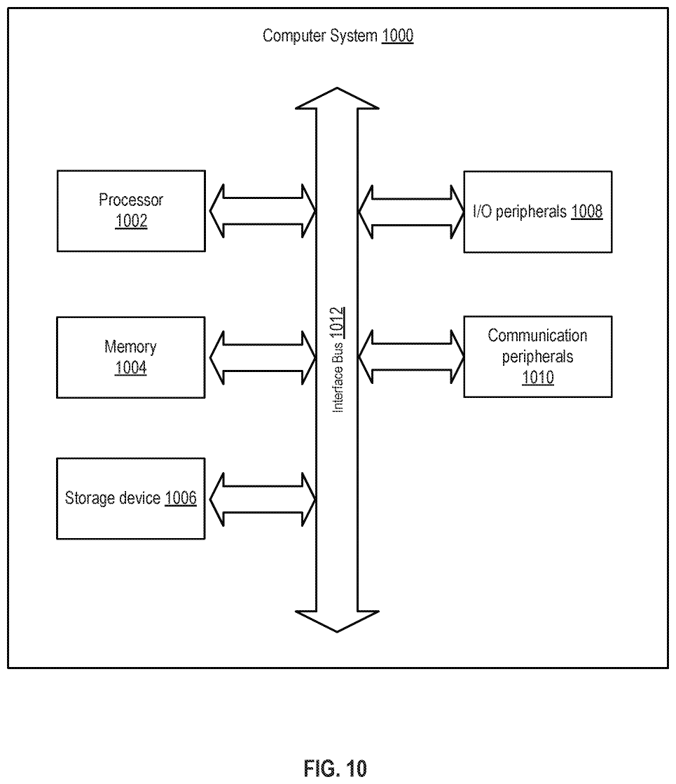

FIG. 10 illustrates an example computer system 1000 for implementing some of the embodiments disclosed herein. For example, computer system 1000 may be used to implement any of the operation server, security server, vehicle electronic system, and the user device described above. Computer system 1000 may have a distributed architecture, where some of the components (e.g., memory and processor) are part of an end user device and some other similar components (e.g., memory and processor) are part of a computer server. Computer system 1000 includes at least a processor 1002, a memory 1004, a storage device 1006, input/output (I/O) peripherals 1008, communication peripherals 1010, and an interface bus 1012. Interface bus 1012 is configured to communicate, transmit, and transfer data, controls, and commands among the various components of computer system 1000. Memory 1004 and storage device 1006 include computer-readable storage media, such as RAM, ROM, electrically erasable programmable read-only memory (EEPROM), hard drives, CD-ROMs, optical storage devices, magnetic storage devices, electronic non-volatile computer storage, for example Flash® memory, and other tangible storage media. Any of such computer-readable storage media can be configured to store instructions or program codes embodying aspects of the disclosure. Memory 1004 and storage device 1006 also include computer-readable signal media. A computer-readable signal medium includes a propagated data signal with computer-readable program code embodied therein. Such a propagated signal takes any of a variety of forms including, but not limited to, electromagnetic, optical, or any combination thereof. A computer-readable signal medium includes any computer-readable medium that is not a computer-readable storage medium and that can communicate, propagate, or transport a program for use in connection with computer system 1000.

Further, memory 1004 includes an operating system, programs, and applications. Processor 1002 is configured to execute the stored instructions and includes, for example, a logical processing unit, a microprocessor, a digital signal processor, and other processors. Memory 1004 and/or processor 1002 can be virtualized and can be hosted within another computing systems of, for example, a cloud network or a data center. I/O peripherals 1008 include user interfaces, such as a keyboard, screen (e.g., a touch screen), microphone, speaker, other input/output devices, and computing components, such as graphical processing units, serial ports, parallel ports, universal serial buses, and other input/output peripherals. I/O peripherals 1008 are connected to processor 1002 through any of the ports coupled to interface bus 1012. Communication peripherals 1010 are configured to facilitate communication between computer system 1000 and other computing devices over a communications network and include, for example, a network interface controller, modem, wireless and wired interface cards, antenna, and other communication peripherals.

It should be appreciated that computer system 1000 is illustrative and not intended to limit embodiments of the present disclosure. Many other configurations having more or fewer components than computer system 1000 are possible. The various embodiments further can be implemented in a wide variety of operating environments, which in some cases can include one or more user computers, computing devices or processing devices, which can be used to operate any of a number of applications. User or client devices can include any of a number of general purpose personal computers, such as desktop or laptop computers running a standard or non-standard operating system, as well as cellular, wireless and handheld devices running mobile software and capable of supporting a number of networking and messaging protocols. Such a system also can include a number of workstations running any of a variety of commercially available operating systems and other known applications for purposes such as development and database management. These devices also can include other electronic devices, such as dummy terminals, thin-clients, gaming systems and other devices capable of communicating via a network.

Most embodiments utilize at least one network that would be familiar to those skilled in the art for supporting communications using any of a variety of commercially available protocols, such as TCP/IP, UDP, OSI, FTP, UPnP, NFS, CIFS, and the like. The network can be, for example, a local area network, a wide-area network, a virtual private network, the Internet, an intranet, an extranet, a public switched telephone network, an infrared network, a wireless network, and any combination thereof.

In embodiments utilizing a network server as the operation server or the security server, the network server can run any of a variety of server or mid-tier applications, including HTTP servers, FTP servers, CGI servers, data servers, Java servers, and business application servers. The server(s) also may be capable of executing programs or scripts in response to requests from user devices, such as by executing one or more applications that may be implemented as one or more scripts or programs written in any programming language, including but not limited to Java®, C, C# or C++, or any scripting language, such as Perl, Python or TCL, as well as combinations thereof. The server(s) may also include database servers, including without limitation those commercially available from Oracle®, Microsoft®, Sybase® and IBM®.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a non-transitory computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services or other elements located within at least one working memory device, including an operating system and application programs, such as a client application or browser. It should be appreciated that alternate embodiments may have numerous variations from that described above. For example, customized hardware might also be used and/or particular elements might be implemented in hardware, software (including portable software, such as applets) or both. Further, connections to other computing devices such as network input/output devices may be employed.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter. The various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art. Indeed, the methods and systems described herein may be embodied in a variety of other forms; furthermore, various omissions, substitutions and changes in the form of the methods and systems described herein may be made without departing from the spirit of the present disclosure. The accompanying claims and their equivalents are intended to cover such forms or modifications as would fall within the scope and spirit of the present disclosure.

Unless otherwise explicitly stated as incompatible, or the physics or otherwise of the embodiments, example or claims prevent such a combination, the features of the foregoing embodiments and examples, and of the following claims may be integrated together in any suitable arrangement, especially ones where there is a beneficial effect in doing so. This is not limited to only any specified benefit, and instead may arise from an “ex post facto” benefit. This is to say that the combination of features is not limited by the described forms, particularly the form (e.g. numbering) of the example(s), embodiment(s), or dependency of the claim(s). Moreover, this also applies to the phrase “in one embodiment”, “according to an embodiment” and the like, which are merely a stylistic form of wording and are not to be construed as limiting the following features to a separate embodiment to all other instances of the same or similar wording. This is to say, a reference to ‘an’, ‘one’ or ‘some’ embodiment(s) may be a reference to any one or more, and/or all embodiments, or combination(s) thereof, disclosed. Also, similarly, the reference to “the” embodiment may not be limited to the immediately preceding embodiment.

Certain figures in this specification are flow charts illustrating methods and systems. It will be understood that each block of these flow charts, and combinations of blocks in these flow charts, may be implemented by computer program instructions. These computer program instructions may be loaded onto a computer or other programmable apparatus to produce a machine, such that the instructions which execute on the computer or other programmable apparatus create structures for implementing the functions specified in the flow chart block or blocks. These computer program instructions may also be stored in a computer-readable memory that can direct a computer or other programmable apparatus to function in a particular manner, such that the instructions stored in the computer-readable memory produce an article of manufacture including instruction structures which implement the function specified in the flow chart block or blocks. The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flow chart block or blocks. Accordingly, blocks of the flow charts support combinations of structures for performing the specified functions and combinations of steps for performing the specified functions. It will also be understood that each block of the flow charts, and combinations of blocks in the flow charts, can be implemented by special purpose hardware-based computer systems which perform the specified functions or steps, or combinations of special purpose hardware and computer instructions. For example, any number of computer programming languages, such as C, C++, C# (CSharp), Perl, JSON, Ada, Python, Pascal, SmallTalk, FORTRAN, assembly language, and the like, may be used to implement machine instructions. Further, various programming approaches such as procedural, object-oriented or artificial intelligence techniques may be employed, depending on the requirements of each particular implementation. Compiler programs and/or virtual machine programs executed by computer systems generally translate higher level programming languages to generate sets of machine instructions that may be executed by one or more processors to perform a programmed function or set of function.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

What is claimed is:

1. A method for securing a vehicle compartment, the method comprising:
receiving authorization data;
setting a mode of operation of an access element based on the authorization data, the access element operable to control a locking mechanism of the vehicle compartment in a vehicle,
wherein the access element is configured to operate in:
a first mode of operation that allows the access element to control the locking mechanism; and
a second mode of operation that prevents the access element from controlling the locking mechanism;
receiving sensor data indicating that the vehicle compartment in the vehicle has been opened; and
in response to the authorization data corresponding to the second mode of operation and the sensor data contemporaneously indicating that the vehicle compartment is opened:
initiating a security protocol.

2. The method of claim 1 wherein the access element is a user accessible button disposed in a cabin of the vehicle and, in response to being activated, is configured to toggle between the first mode of operation and the second mode of operation.

3. The method of claim 1 wherein the authorization data indicates whether a user accessing the vehicle has security privileges, wherein the access element is set to the first mode of operation when the authorization data indicates that the user has security privileges, and wherein the access element is set to the second mode of operation when the authorization indicates that the user does not have security privileges.

4. The method of claim 1 wherein the sensor data further indicates when one or more components within the vehicle compartment has been tampered with, and
wherein initiating the security protocol is further performed in response to the authorization data corresponding to the second mode of operation and the sensor data contemporaneously indicating that the one or more components within the vehicle compartment has been tampered with.

5. The method of claim 1 wherein the sensor data is received from one or more motion sensors configured to detect when the vehicle compartment is opened.

6. The method of claim 1 wherein the sensor data is received from one or more light sensors configured to detect when the vehicle compartment is opened based on a change of an ambient light intensity within the vehicle compartment.

7. The method of claim 1 wherein initiating a security protocol includes one or more of:
triggering an alarm system;
alerting one or more security entities; and
transmitting an alert to vehicle fleet management server, the vehicle fleet management server providing the authorization data.

8. A security system for a vehicle comprising:
an electronic control unit (ECU) disposed in the vehicle;
an inertial measurement unit (IMU) physically coupled to the electronic control unit and configured to detect a movement of the ECU; and
an access control module (ACM) communicatively coupled to the ECU and IMU, the ACM configured to receive security data corresponding to a security privilege for a user of the vehicle,
wherein the ACM is configured to trigger an alarm in response to the security data indicating that the user does not have a security privilege and the IMU contemporaneously detecting a movement of the ECU.

9. The security system of claim 8 wherein the ECU is housed in a vehicle compartment inside the vehicle, wherein the ACM is configured to control access to the vehicle compartment based on the security privilege for the user.

10. The security system of claim 9 wherein an access element is disposed in a cabin of the vehicle that is operable to control a locking mechanism of the vehicle compartment, wherein the ACM enables the access element in response to determining that the user has the security privilege, and wherein the ACM disables the access element in response to determining that the user does not have the security privilege.

11. The security system of claim 8 further comprising a light sensor configured to detect a change in an ambient light within a perimeter of the ECU, and wherein the ACM is further configured to control access to the vehicle compartment based on the light sensor contemporaneously detecting changes in the ambient light within the perimeter of the ECU that is greater than a threshold value.

12. The security system of claim 8 wherein the ACM is configured to trigger the alarm in response to the security data indicating that the user does not have a security privilege, the IMU contemporaneously detecting a movement of the ECU, and the ACM contemporaneously receiving data indicating that the vehicle is not in motion.

13. The security system of claim 9 wherein the ACM may be further configured to:
alert one or more security entities; or
transmit an alert to vehicle fleet management server, the vehicle fleet management server providing the authorization data.

14. A system for securing a vehicle compartment, the system comprising:
one or more processors;
one or more non-transitory computer readable mediums storing instructions configured to cause the one or more processors to perform operations including:
receiving authorization data;
setting a mode of operation of an access element based on the authorization data, the access element operable to control a locking mechanism of the vehicle compartment in a vehicle,
wherein the access element is configured to operate in:
a first mode of operation that allows the access element to control the locking mechanism; and
a second mode of operation that prevents the access element from controlling the locking mechanism;
receiving sensor data indicating that the vehicle compartment in the vehicle has been opened; and
in response to the authorization data corresponding to the second mode of operation and the sensor data contemporaneously indicating that the vehicle compartment is opened:
initiating a security protocol.

15. The system of claim 14 wherein the access element is a user accessible button disposed in a cabin of the vehicle and, in response to being activated, is configured to toggle between the first mode of operation and the second mode of operation.

16. The system of claim 14 wherein the authorization data indicates whether a user accessing the vehicle has security privileges, wherein the access element is set to the first mode of operation when the authorization data indicates that the user has security privileges, and
wherein the access element is set to the second mode of operation when the authorization indicates that the user does not have security privileges.

17. The system of claim 14 wherein the sensor data further indicates when one or more components within the vehicle compartment has been tampered with, and
wherein initiating the security protocol is further performed in response to the authorization data corresponding to the second mode of operation and the sensor data contemporaneously indicating that the one or more components within the vehicle compartment has been tampered with.

18. The system of claim 14 wherein the sensor data is received from one or more motion sensors configured to detect when the vehicle compartment is opened.

19. The system of claim 14 wherein the sensor data is received from one or more light sensors configured to detect when the vehicle compartment is opened based on a change of an ambient light intensity within the vehicle compartment.

20. The system of claim 14 wherein initiating a security protocol includes one or more of:
triggering an alarm system;
alerting one or more security entities; and
transmitting an alert to vehicle fleet management server, the vehicle fleet management server providing the authorization data.
